(19) United States
(12) Patent Application Publication
(10) Pub. No.: US 2002/0110129 A1
(43) Pub. Date: Aug. 15, 2002

(54) Scheduling method and scheduling apparatus

(76) Inventors: Naoki Matsuoka, Kawasaki (JP); Hiroshi Tomonaga, Kawasaki (JP); Kenichi Kawarai, Kawasaki (JP); Masakatsu Nagata, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/973,628

(22) Filed: Oct. 9, 2001

(30) Foreign Application Priority Data
Feb. 9, 2001 (JP) 2001-034339

(51) Int. Cl. H04L 12/54

(52) U.S. Cl. 370/395.42; 370/402

(57) ABSTRACT

A scheduling method includes the steps of processing scheduling processes of all input lines according to a processing sequence in which a highest priority output line of a highest priority input line is processed with a first priority, in an environment in which a plurality of processing sequences have different scheduling targets among a plurality of input lines, and updating the highest priority input line and the highest priority output line of each input line for every scheduling cycle.

### BACKGROUND OF THE INVENTION

This application claims the benefit of a Japanese Patent Application No.2001-034339 filed Feb. 9, 2001, in the Japanese Patent Office, the disclosure of which is hereby incorporated by reference.

1. Field of the Invention

The present invention generally relates to scheduling methods and scheduling apparatuses, and more particularly to a scheduling method for realizing an efficient packet read-out at an input buffer type switch, and to a scheduling apparatus which employs such a scheduling method.

2. Description of the Related Art

Recently, due to the increase of Internet traffic, there are demands to increase the capacity of the Internet backbone network. As a result, a switching capacity exceeding 1 terabits becomes required in a network node which is set up within the backbone network.

Presently, as a means of realizing a large-capacity node, there are great expectations on an input buffer type switch which is capable of reducing a memory access time. The input buffer type switch has a structure provided with a packet buffer with respect to each input line, and has advantages in that the memory access speed for realizing a packet buffer is low and that it is easy to realize by hardware.

However, because the packet buffer is not provided in the switch section, it is necessary to make a scheduling so that different input lines do not transmits packets to the same output line at the same time. For this reason, a scheduling process must be carried out at each buffer to adjust the timings, and there is a possibility of deteriorating the throughput if an efficient scheduling process cannot be realized. Various algorithms have been proposed with respect to the scheduling process for the input buffer type switch.

FIGS. 1A through IC respectively are diagrams for explaining a first example of a conventional scheduling method. In FIGS. 1A through 1C, a circular mark indicates an output line which is requested, and a circular mark with hatching indicates a state where the scheduling is determined.

In FIG. 1A, the scheduling is started from an arbitrary input line of input lines i#0 through i#3, and a scheduling is made to sequentially select undetermined output lines according to a round-robin format for each of the input lines. In addition, the processing sequence is fixedly changed recursively for each scheduling cycle so as to realize an unbiased scheduling. For example, in a first scheduling cycle, the scheduling is made in the order of the input line i#2, the input line i#3, the input line i#0 and the input line i#1 as shown in FIG. 1B, and in a following second scheduling cycle, the scheduling is made in the order of the input line i#3, the input line i#0, the input line i#1 and the input line i#2 as shown in FIG. 1C.

FIGS. 2A through 2C respectively are diagrams for explaining a second example of the conventional scheduling method. In order to reduce the processing time, this second example of the conventional scheduling method carries out the processes of N input lines in parallel according to processing sequences of input lines having different scheduling targets. In addition, the processing sequence is fixedly changed recursively for each scheduling cycle in order to realize an unbiased scheduling.

In a first scheduling cycle, the scheduling of the input line i#0 is made with respect to output lines o#0, o#1, o#2 and o#3 in this priority sequence, as shown in FIG. 2A. At the same time, the scheduling of the input line i#1 is made with respect to output lines o#1, o#2, o#3 and o#0 in this priority sequence, as shown in FIG. 2A. In addition, at the same time, the scheduling of the input line i#2 is made with respect to output lines o#2, o#3, o#0 and o#1 in this priority sequence, as shown in FIG. 2A. Furthermore, at the same time, the scheduling of the input line i#3 is made with respect to output lines o#3, o#0, o#1 and o#2 in this priority sequence, as shown in FIG. 2A. FIG. 2B shows an equivalent priority sequence pattern for the case shown in FIG. 2A.

Moreover, in a second scheduling cycle, the scheduling of each of the input lines i#0 through i#3 is made with respect to the output lines o#0 through o#3 by fixedly changing the priority sequence recursively, similarly to the first scheduling cycle. As a result, an equivalent priority sequence pattern of this case becomes as shown in FIG. 2C.

According to the first example of the conventional scheduling method shown in FIGS. 1A through 1C, the processing sequence of the input lines is changed recursively for each scheduling cycle, and the output lines are selected according to the round-robin format. For this reason, it is process each of the input lines and the output lines in an unbiased manner, and the scheduling can be made efficiently because the processing is made sequentially for each input line. However, since the scheduling process is a sequential process, the time required for the scheduling process becomes large compared to N, that is, the number of lines. Consequently, the processing does not end within a unit time in a region where the number N of input lines is large, and it becomes necessary to apply a pipeline processing to carry out a plurality of processes in parallel.

Accordingly, although the first example of the conventional scheduling method is an effective method of realizing an efficient scheduling, the time required for the scheduling process becomes large in the region where the number N of lines is large. For this reason, it becomes necessary to carry out an extremely large number of pipeline processings, and there was a problem in that the required hardware is greatly increased thereby.

On the other hand, the second example of the conventional scheduling method processes the N input lines in parallel, and the time required for the scheduling process can be reduced to approximately 1/N the time required by the first example of the conventional scheduling method. However, the sequential control of the scheduling is such that the processing sequence of each of the input lines is fixedly changed recursively. As a result, the processing with respect to a specific output line from different input lines becomes biased. For example, when selecting the output line o#1 from the input lines i#0 and i#1, the input line i#0 is selected according to the sequence shown in FIG. 2C, but the input line i#1 is selected according to the sequence shown in FIG. 2B and two other sequences which are not shown, and there was a problem in that an unbiased scheduling cannot be made.

Hence, although the second example of the conventional scheduling method is an effective method of reducing the time required for the scheduling process, there was a problem in that an unbiased scheduling cannot be made and the throughput is deteriorated thereby.

### SUMMARY OF THE INVENTION

Accordingly, it is a general object of the present invention to provide a novel and useful scheduling method and scheduling apparatus, in which the problems described above are eliminated.

Another and more specific object of the present invention is to provide a scheduling method and a scheduling apparatus which can reduce a time required for a scheduling process, and at the same time realize an unbiased scheduling.

Still another object of the present invention is to provide a scheduling method comprising the steps of (a) processing scheduling processes of all input lines according to a processing sequence in which a highest priority output line of a highest priority input line is processed with a first priority, in an environment in which a plurality of processing sequences have different scheduling targets among a plurality of input lines, and (b) updating the highest priority input line and the highest priority output line of each input line for every scheduling cycle. According to the scheduling method of the present invention, it is possible to always determine the highest priority output line of the input line when each input line becomes the highest priority line. When attention is drawn to a single input line, the output lines of this input line are uniformly selected, and it is possible to realize an unbiased scheduling even if the sequence is fixed among the input lines. At the same time, it is possible to reduce the processing time by employing a parallel process, so that the scheduling can be carried out at a high speed.

The step (b) may select with priority a line in which a packet exists, when updating the highest priority input line and the highest priority output line of each input line. In this case, the line having no request is not selected. Thus, even under a non-uniform path condition where the number of paths differ among the input lines, only the line in which a traffic exists is selected as the highest priority line, so that an unbiased scheduling is possible under various conditions.

A further object of the present invention is to provide a scheduling apparatus comprising scheduling processing means for processing scheduling processes of all input lines according to a processing sequence in which a highest priority output line of a highest priority input line is processed with a first priority, in an environment in which a plurality of processing sequences have different scheduling targets among a plurality of input lines, and priority line updating means for updating the highest priority input line and the highest priority output line of each input line for every scheduling cycle. According to the scheduling apparatus of the present invention, it is possible to always determine the highest priority output line of the input line when each input line becomes the highest priority line. When attention is drawn to a single input line, the output lines of this input line are uniformly selected, and it is possible to realize an unbiased scheduling even if the sequence is fixed among the input lines. At the same time, it is possible to reduce the processing time by employing a parallel process, so that the scheduling can be carried out at a high speed.

The priority line updating means may select with priority a line in which a packet exists, when updating the highest priority input line and the highest priority output line of each input line. In this case, the line having no request is not selected. Thus, even under a non-uniform path condition where the number of paths differ among the input lines, only the line in which a traffic exists is selected as the highest priority line, so that an unbiased scheduling is possible under various conditions.

The priority line updating means may not update the highest priority output line of each input line when updating the highest priority output line if the highest priority output line cannot be scheduled. In this case, even if a line other than the highest priority output line is selected during the present scheduling cycle, it is possible to select the highest priority output line with priority in the next or subsequent scheduling cycles.

The priority line updating means may update the highest priority output line of each input line by selecting a priority line within the output lines with priority over a non-priority line within the output lines. In this case, it is possible to select with priority a line having a large load, a line having a long queue length, an output line having a severe quality requirement such as QoS, for example, and an unbiased scheduling is possible even when the traffic is non-uniform among the output lines of the same input line. In addition, when selecting the line with priority based on the QoS, it is possible to guarantee the delay and the band of the line which is selected with priority based on the QoS, without being affected by the best effort traffic.

The scheduling processing means may independently manage the highest priority output line with respect to the priority line and the non-priority line. In this case, it is possible to independently schedule the priority line and the non-priority line.

The scheduling processing means may collectively manage the highest priority output line with respect to the priority line and the non-priority line. In this case, it is possible to reduce the processing time of the scheduling process by carrying out the scheduling while selecting the priority line with priority when updating the highest priority line.

The scheduling processing means may carry out a scheduling with respect to the non-priority line after carrying out a scheduling with respect to the priority line in a first half of a scheduling cycle. In this case, it is possible to completely process the priority line with priority with respect to all lines, and an efficient scheduling is possible by allocating the undetermined vacant band for the non-priority line.

The scheduling processing means may carry out schedulings with respect to the priority line and the non-priority line in parallel, and selects a scheduling result of the priority line with priority when a contention is generated between the scheduling result of the priority line and a scheduling result of the non-priority line. In this case, it is possible to reduce the processing time of the scheduling process while processing the priority line with priority.

The priority line updating means may select and update a high priority group within the output lines with priority over a low priority group within the output lines when updating the highest priority output line of each input line. In this case, it is possible to select with priority a line having a large load, a line having a long queue length, an output line having a severe quality requirement such as QoS, for example, and an unbiased scheduling is possible even when the traffic is non-uniform among the output lines of the same input line. In addition, when selecting the line with priority based on the QoS, it is possible to guarantee the delay and the band of the line which is selected with priority based on the QoS, without being affected by the best effort traffic.

The scheduling processing means may independently manage the highest priority output line with respect to the high priority group and the low priority group. In this case, it is possible to independently schedule the high priority group and the low priority group.

The scheduling processing means may collectively manage the highest priority output line with respect to the high priority group and the low priority group. In this case, it is possible to reduce the processing time of the scheduling process while scheduling the priority line with priority by selecting the high priority group with priority when updating the highest priority line.

Another object of the present invention is to provide a scheduling apparatus comprising scheduling processing means for processing scheduling processes of all output lines according to a processing sequence in which a highest priority input line of a highest priority output line is processed with a first priority, in an environment in which a plurality of processing sequences have different scheduling targets among a plurality of output lines, and priority line updating means for updating the highest priority output line and the highest priority input line of each output line for every scheduling cycle. According to the scheduling apparatus of the present invention, it is possible to always determine the highest priority input line of the output line when each output line becomes the highest priority line. When attention is drawn to a single output line, the input lines of this output line are uniformly selected, and it is possible to realize an unbiased scheduling even if the sequence is fixed among the output lines. At the same time, it is possible to reduce the processing time by employing a parallel process, so that the scheduling can be carried out at a high speed.

Other objects and further features of the present invention will be apparent from the following detailed description when read in conjunction with the accompanying drawings.

### BRIEF DESCRIPTION OF THE DRAWINGS

FIGS. 1A through 1C respectively are diagrams for explaining a first example of a conventional scheduling method;

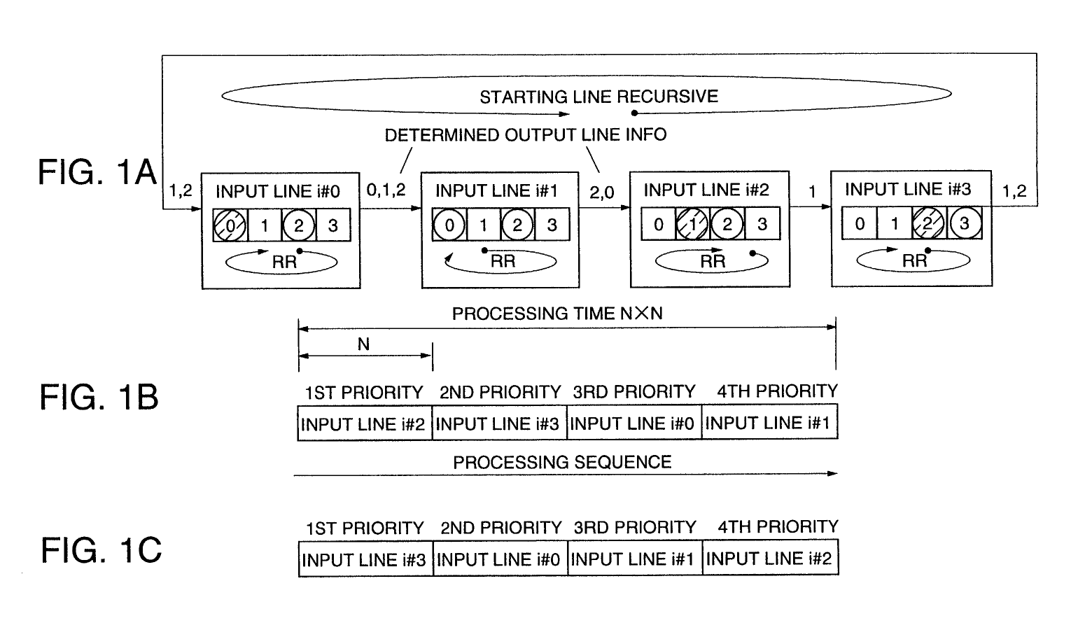

FIGS. 2A through 2C respectively are diagrams for explaining a second example of the conventional scheduling method;

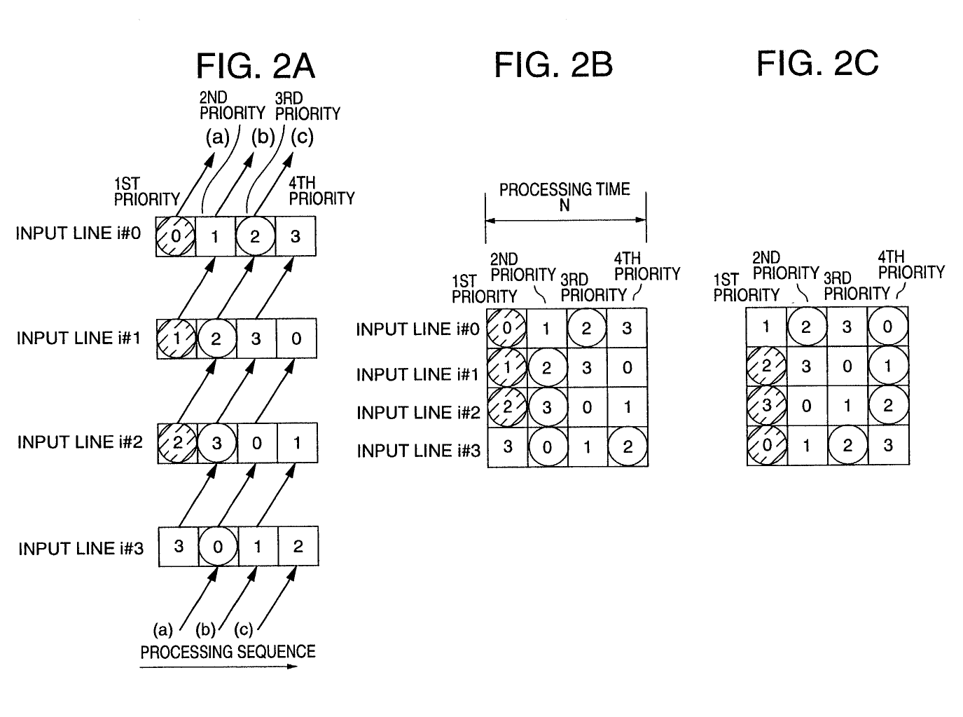

FIG. 3 is a system block diagram showing a first embodiment of an input buffer type switch used by a first embodiment of a scheduling method according to the present invention;

FIG. 4 is a diagram for explaining the process of the first embodiment of the scheduling method;

FIG. 5 is a diagram for explaining the process of the first embodiment of the scheduling method;

FIG. 6 is a flow chart for explaining a scheduling process of the first embodiment of the scheduling method;

FIG. 7 is a diagram for explaining a pointer initial value, a used processing pattern, an existence of scheduling request, a scheduling result, and a pointer value after pointer updating, for each scheduling cycle;

FIG. 8 is a diagram for explaining the pointer initial value, the used processing pattern, the existence of scheduling request, the scheduling result, and the pointer value after pointer updating, for each scheduling cycle;

FIG. 9 is a diagram for explaining the pointer initial value, the used processing pattern, the existence of scheduling request, the scheduling result, and the pointer value after pointer updating, for each scheduling cycle;

FIG. 10 is a diagram for explaining the pointer initial value, the used processing pattern, the existence of scheduling request, the scheduling result, and the pointer value after pointer updating, for each scheduling cycle;

FIG. 11 is a diagram for explaining an updating process of a highest priority input line for a case where the state of the existence of the scheduling request is different before and after the scheduling;

FIG. 12 is a diagram for explaining the process of a second embodiment of the scheduling method according to the present invention;

FIG. 13 is a flow chart for explaining a priority scheduling collective process of the second embodiment of the scheduling method;

FIG. 14 is a flow chart for explaining the priority scheduling collective process of the second embodiment of the scheduling method;

FIG. 15 is a diagram for explaining an example of an operation of the priority scheduling collective process;

FIG. 16 is a flow chart for explaining a first embodiment of a priority scheduling sequential process;

FIG. 17 is a flow chart for explaining a second embodiment of the priority scheduling sequential process;

FIG. 18 is a diagram for explaining an example of an operation of the first embodiment of the priority scheduling sequential process;

FIG. 19 is a flow chart for explaining a first embodiment of a priority scheduling parallel process;

FIG. 20 is a diagram for explaining an example of an operation of the first embodiment of the priority scheduling parallel process;

FIG. 21 is a diagram for explaining a third embodiment of the priority scheduling sequential process;

FIG. 22 is a flow chart for explaining the third embodiment of the priority scheduling sequential process;

FIG. 23 is a flow chart for explaining a fourth embodiment of the priority scheduling sequential process;

FIG. 24 is a diagram for explaining an example of an operation of the third embodiment of the priority scheduling sequential process;

FIG. 25 is a flow chart for explaining a second embodiment of the priority scheduling parallel process;

FIG. 26 is a diagram for explaining an example of an operation of the second embodiment of the priority scheduling parallel process;

FIG. 27 is a diagram for explaining a fourth embodiment of the scheduling method according to the present invention;

FIG. 28 is a diagram for explaining the fourth embodiment of the scheduling method;

FIG. 29 is a diagram for explaining a pointer initial value, a used processing pattern, an existence of scheduling request, a scheduling result, and a pointer value after pointer updating, for each scheduling cycle;

FIG. 30 is a diagram for explaining the pointer initial value, the used processing pattern, the existence of scheduling request, the scheduling result, and the pointer value after pointer updating, for each scheduling cycle;

FIG. 31 is a system block diagram showing a second embodiment of the input buffer type switch used by a fifth embodiment of the scheduling method according to the present invention; and

FIG. 32 is a diagram showing a relationship of processes of four schedulers and packet transmissions.

### DESCRIPTION OF THE PREFERRED EMBODIMENTS

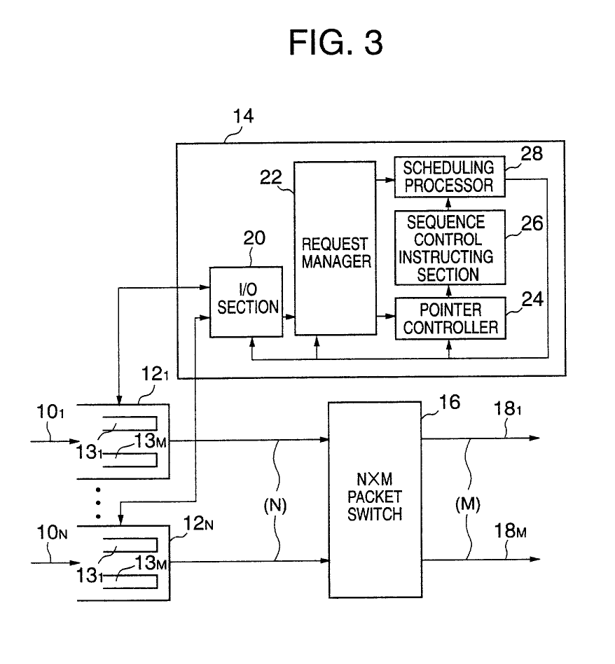

FIG. 3 is a system block diagram showing a first embodiment of an input buffer type switch used by a first embodiment of a scheduling method according to the present invention. As shown in FIG. 3, a number of input buffer sections 12₁ through 12_{N} corresponds to a number of input lines 101 through 10_{N}, and logical output queues (hereinafter referred to as Virtual Output Queues or, simply VOQs) 13₁ through 13_{M} corresponding to output lines are provided in each of the input buffer sections 12₁ through 12_{N}. In each of the input buffer sections 12₁ through 12_{N}, an input packet are buffered in the VOQs 13₁ through 13_{M} corresponding to the output lines, and in addition to this buffering, the VOQs 13₁ through 13_{M} transmit request information of scheduling requests to a scheduling apparatus (hereinafter simply referred to as a scheduler) 14. Each of the input buffer sections 12₁ through 12_{N} transmits the packet from one of the VOQs 13₁ through 13_{M} to a packet switch 16 depending on an instruction, that is, a scheduling result, obtained from the scheduler 14.

The packet switch 16 is made of a bufferless crossbar switch which does not use a buffer. This packet switch 16 switches the packet to one of output lines 181 through 18M depending on a destination written in a header of the packet.

The scheduler 14 includes an input/output (I/O) section 20, a request manager 22, a pointer controller 24, a sequence control instructing section 26, and a scheduling processor 28. The scheduler 14 carries out a scheduling so that no contention is generated at the packet switch 16. The I/O section 20 receives the request information from the input buffer sections 12₁ through 12_{N}, and notifies the request information to the request manager 22. In addition, the I/O section 20 notifies the scheduling result from the scheduling processor 28 to each of the input buffer sections 12₁ through 12_{N}.

The request manager 22 manages the number of scheduling requests transmitted from each of the input buffer sections 12₁ through 12_{N} for each of the VOQs 13₁ through 13_{M} within the input buffer sections 12₁ through 12_{N}, and judges whether or not the scheduling request exists. The pointer controller 24 manages one of the input lines 10₁ through 10_{N} having a highest priority (hereinafter referred to as a highest priority input line), and one of the output lines 18₁ through 18_{M} having a highest priority (hereinafter referred to as a highest priority output line) for each of the input lines 10₁ through 10_{N}. The sequence control instructing section 26 can schedule the highest priority output line of the highest priority input line notified from the pointer controller 24 with a first priority. In other words, the sequence control instruction section 26 can schedule, based on the notification from the pointer controller 24, the output line which is specified as having the highest priority and corresponding to the input line which is specified as having the highest priority, with the first priority. In addition, the sequence control instruction section 26 generates a scheduling sequence such that scheduling targets of each of the input lines 10₁ through 10_{N} do not overlap, and notifies this scheduling sequence to the scheduling processor 28.

The scheduling processor 28 carries out the scheduling processes of the N input lines 10₁ through 10_{N} in parallel according to the scheduling sequence notified from the sequence control instruction section 26, using the information indicating the existence of the scheduling request notified from the request manager 22 and information managed by the scheduling processor 28 and indicating the lines which are determined. Hence, by carrying out the scheduling processes of all of the input lines 10₁ through 10_{N} according to the processing sequence which processes the highest priority output line of the highest priority input line specified by the pointer controller 24 with the first priority, and updating the highest priority input line and the highest priority input line of each input line for every scheduling cycle, it is possible to realize an unbiased scheduling wherein a time required for the scheduling process is reduced.

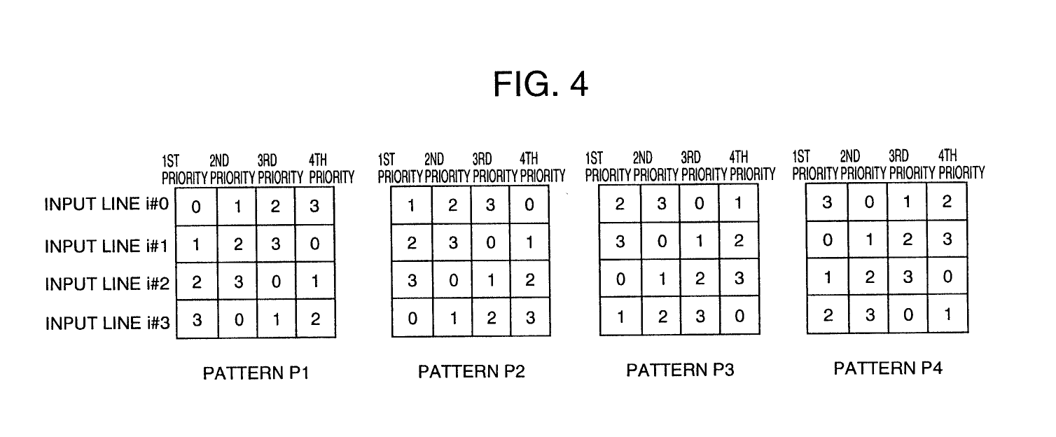

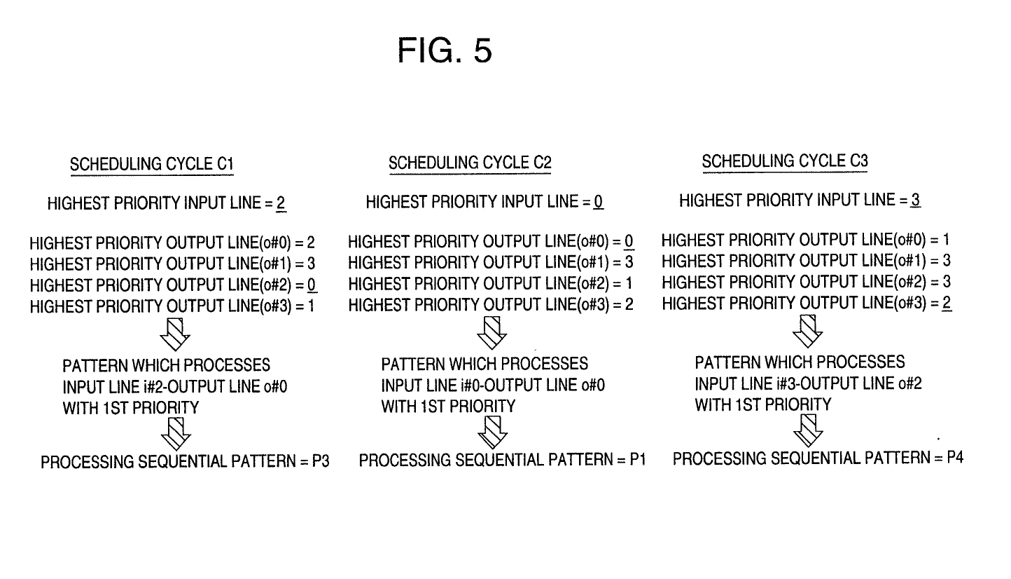

Next, a description will be given of the operation of this first embodiment of the scheduling method for a particular case, by referring to FIGS. 4 and 5. In this particular case, it is assumed for the sake of convenience that the number N of input lines 10₁ through 10_{N} is N=4, the number M of output lines 18₁ through 18_{M} is M=4, and a 4×4 crossbar switch is used for the packet switch 16. In the following description, the input lines 10₁ through 10₄ will also be referred to as input lines i#0 through i#3, and the output lines 18₁ through 18₄ will also be referred to as output lines o#0 through o#3.

FIG. 4 is a diagram for explaining the process of this first embodiment of the scheduling method, related to the processing sequence of the scheduling generated by the sequence control instruction section 26 of the scheduler 14. Each of matrixes of sequential patterns P1 through P4 shown in FIG. 4 represents the scheduling target of the input line i#0 by a first row, the scheduling target of the input line i#1 by a second row, the scheduling target of the line i#2 by a third row, and the scheduling target of the input line i#3 by a fourth row. In addition, in each of the matrixes, a first column represents a first priority of the processing sequence, a second column represents a second priority of the processing sequence, a third column represents a third priority of the processing sequence, and a fourth column represents a fourth priority of the processing sequence. Numerals indicated in each row and each column represent the output line number, and a numeral “1” represents the output line o#1, for example.

In the case of the sequential pattern P1, for example, the input line i#0 regards the output line o#0 as the scheduling target with the first priority, the input line i#1 regards the output line o#1 as the scheduling target with the first priority, the input line i#2 regards the output line o#2 as the scheduling target with the first priority, and the input line i#3 regards the output line o#3 as the scheduling target with the first priority. In addition, from the input line i#0, the scheduling sequence is in the order of the output lines o#0, o#1, o#2 and o#3.

The scheduling process is realized by successively carrying out the judgement process with respect to the output lines o#0 through o#3 which are the scheduling targets, from the first priority to the Nth priority, at the same time by the four input lines i#0 through i#3. The scheduling target for the same processing time (same priority sequence) differs depending on the input line, and it is unnecessary to be aware of the scheduling results of other input lines during the same processing time. For this reason, it is possible to carry out the scheduling process at a high speed. Since the 4×4 crossbar switch is used for the packet switch 16 in this particular case, four sequential patterns in which each of the output lines o#0 through o#3 uniformly becomes the highest priority output line, exist as sequential patterns of the scheduling sequence.

In general, each of the output lines 181 through 18M uniformly becomes the first priority output line by generating N! sequential patterns, but in this case, the number of sequential patterns becomes extremely large and impractical when the number N of input lines 101 through 10N becomes large. On the other hand, it is relatively easy to realize N sequential patterns such that each of the output lines 180 through 18M uniformly becomes the first priority, and the logic for generating the scheduling sequence is extremely simple and easy in this case. With respect to the processing sequence within the sequential pattern, the scheduling target having an mth priority is obtained from [{output line number having (m−1)th priority}+1] MOD N, that is, a remainder which is obtained by dividing [{output line number having (m−1)th priority}+1] by N. In addition, with respect to the generation of the plurality of sequential patterns, an mth sequential pattern is obtained from [{output line number having (m−1)th sequential pattern}+1] MOD N, that is, a remainder which is obtained by dividing [{output line number having (m−1)th sequential pattern}+1] by N. Hence, the priority sequence can be obtained by a simple control. Furthermore, the method of obtaining the scheduling target having the mth priority is not limited to the method which obtains [{output line number having (m−1)th priority}+1] MOD N, that is, a remainder which is obtained by dividing [{output line number having (m−1)th priority}+1] by N, and other methods may be used obtain the scheduling target having the mth priority. Similarly, the method of obtaining the mth sequential pattern is not limited to the method which obtains [{output line number having (m−1)th sequential pattern}+1] MOD N, that is, a remainder which is obtained by dividing [{output line number having (m−1)th sequential pattern}+1] by N, and other methods may be used obtain the mth sequential pattern.

Next, a description will be given of the method of determining the scheduling sequence which is used by the scheduling process, by referring to FIG. 5. FIG. 5 is a diagram for explaining the process of this first embodiment of the scheduling method, related to the method of determining the scheduling sequence used by the scheduling process. It is assumed for the sake of convenience that the pointer controller 24 of the scheduler 14 manages the highest priority input line number of all of the input lines 10₁ through 10_{N}, and the highest priority output line number with respect to each of the input lines 10₁ through 10_{N}.

In FIG. 5, during a scheduling cycle C1, initial pointer values are set so that the highest priority input line number is 2, the highest priority output line number of the input line i#0 is 2, the highest priority output line number of the input line i#1 is 3, the highest priority output line number of the input line i#2 is 0, and the highest priority output line number of the input line i#3 is 1. The scheduling sequence uses the sequential pattern with which the highest priority output line of the highest priority input line is processed with the first priority. In other words, in this particular case, the scheduling is carried out according to the sequential pattern P3 which can process the input line i#2 and the output line o#0 with the first priority. The highest priority input line and the highest priority output line are updated for every scheduling cycle.

Similarly, during a scheduling cycle C2, the scheduling is carried out according to the sequential pattern P1 which can process the input line i#0 and the output line o#0 with the first priority, based on each of the pointer values updated during the scheduling cycle C1. By recursively changing the highest priority input line for every scheduling cycle and carrying out the scheduling of all of the lines according to the sequence in which the highest priority output line with respect to the highest priority input line is processed with the first priority, it is possible to realize an unbiased scheduling.

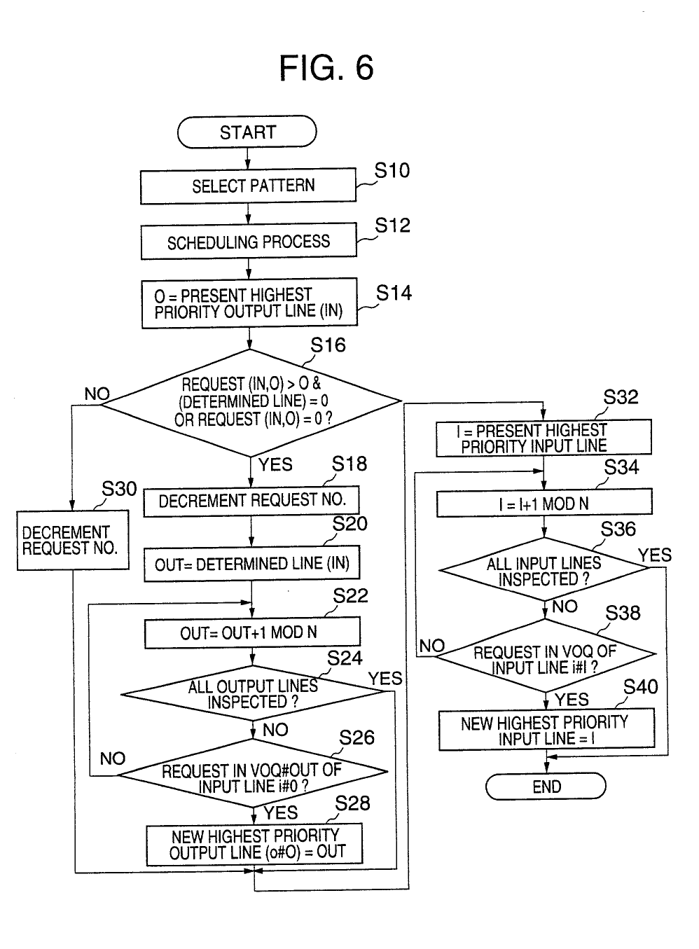

FIG. 6 is a flow chart for explaining the scheduling process of this first embodiment of the scheduling method. In the following description, N denotes the total number of input lines, IN denotes the input line number, O, OUT and I respectively denote intermediate variables, and request(IN, O) denotes a number of requests of a VOQ (logical output queue) #0 of the input line i#IN.

In FIG. 6, a step S10 selects the sequential pattern with which the highest priority output line of the highest priority input line is processed with the first priority. A step S12 carries out the scheduling process according to the processing sequence of the selected sequential pattern. Then, steps S14 through S30 are carried out for every input line.

The step S14 stores the highest priority output line number with respect to the present input line IN into O. The step S16 decides whether or not, a condition that Request(IN, O)>0 and the determined line is O or, a condition that request(IN, O)=0, is satisfied. If one of these conditions is satisfied, the decision result in the step S16 is YES, and the process advances to the step S18. On the other hand, if request(IN, O)>0 and the determined line is not O, the decision result in the step S16 is NO, and the process advances to the step S30.

The step S18 decrements the request number of the determined line by one. The step S20 stores the determined line of the input line i#IN into OUT. The step S22 computes [OUT+1] MOD N and stores the computed value into OUT. The step S24 decides whether or not the inspection is made for all of the output lines. If the decision result in the step S24 is NO, the step S26 decides whether or not a request exists in the VOQ #OUT of the input line i#O.

The process returns to the step S22 if the decision result in the step S26 is NO. If the decision result in the step S26 is YES, the step S28 newly sets the line number stored in OUT to the highest priority output line number stored in O, and the process advances to a step S32. The process also advances to the step S32 if the decision result in the step S24 is YES. On the other hand, if request(IN, O)>0 and the determined line is not O, that is, if the decision result in the step S16 is NO, the step S30 decrements the request number of the determined line by one, and the process advances to the step S32.

The step S32 stores the present highest priority input line number into I. Then, a step S34 computes [I+1] MOD N, and stores the computed value into I. A step S36 decides whether or not the inspection is made for all of the input lines. If the decision result in the step S36 is NO, a step S38 decides whether or not a request exists in one of the VOQs of the input line i#I. If the decision result in the step S38 is NO, the process returns to the step S34. On the other hand, if the decision result in the step S38 is YES, a step S40 newly sets the line number stored in I to the highest priority input line number, and the process ends. The process also ends if the decision result in the step S36 is YES.

Next, a description will be given of a scheduling judging process and the updating of the highest priority input line and the highest priority output line when carrying out the scheduling process of this embodiment of the scheduling method. In this case, it is also assumed for the sake of convenience that the 4×4 crossbar switch is used for the packet switch 16, and the four sequential patterns P1 through P4 shown in FIG. 4 are used.

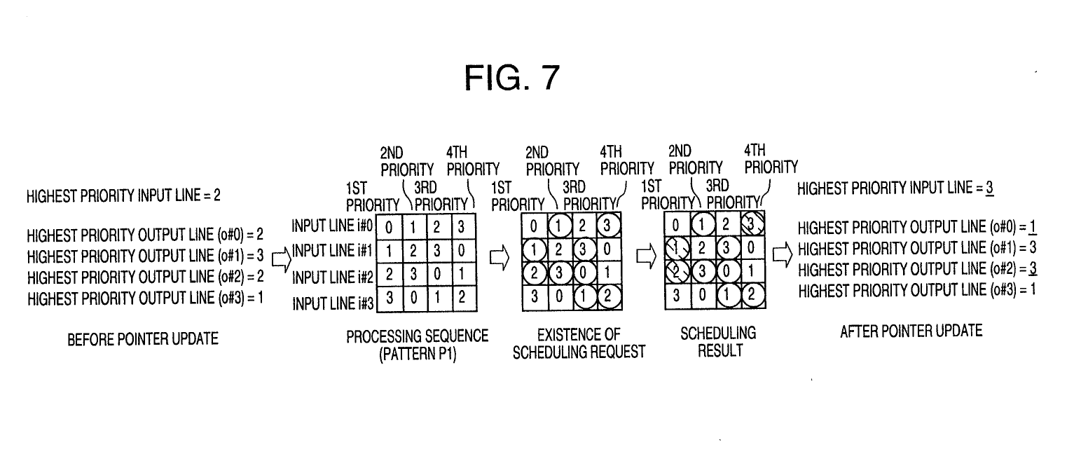

FIGS. 7 through 10 respectively are diagrams for explaining a pointer initial value, a used processing pattern, an existence of scheduling request, a scheduling result, and a pointer value after pointer updating, for each scheduling cycle. The existence of scheduling request is managed by the request manager 22, and it is regarded that the scheduling request exists when the number of scheduling requests is one or greater. In FIGS. 7 through 10, a circular mark indicates that the scheduling request exists. For example, FIG. 7 indicates that for the first priority, the scheduling request from the input line i#1 to the output line o#1 and the scheduling request from the input line i#2 to the output line o#2 exist, and that no scheduling request exists for the input lines i#0 and i#3. The number of scheduling requests is managed by incrementing the number at the time of receiving the scheduling request from the input buffer section, and decrementing the number upon completion of the scheduling. In order to simplify the description, it is assumed for the sake of convenience that two or more scheduling requests exist for the line to which the scheduling request is presently made, and that the existence of the scheduling request does not change before and after the scheduling.

First, a general description will be given of the scheduling process. In the scheduling cycle C1 shown in FIG. 7, the input line i#2 is the highest priority input line, and the output line o#2 is the highest priority output line of the input line i#2. Thus, the sequential pattern P1 is used which processes the input line i#2 and the output line o#2 with the first priority. The scheduling process judges whether or not the scheduling is possible, from the first priority to the Nth priority of the sequential pattern P1, successively by N parallel processes, where N=4 in this case.

It is judged that the scheduling is possible if the input line is undetermined, the output line which is the scheduling target is undetermined, and the scheduling request exists. Otherwise, if the above described conditions are not satisfied, it is judged that the scheduling is not possible. When it is judged that the scheduling is possible, the input line number and the corresponding output line number are set to determined states, and the scheduling result is held. For example, in the first priority process, all of the input lines are undetermined and all of the output lines are undetermined. Accordingly, the input line i#1 and the input line i#2 to which the scheduling request exists both satisfy all of the conditions, and it is judged that the scheduling of these input lines i#1 and i#2 is possible. In FIG. 7 and FIGS. 8 through 10 which will be described later, a circular mark with hatching indicates a state where the scheduling is determined.

Next, in the second priority process, the input line i#0 waits for the scheduling request of the output line o#1, but the output line o#1 is already determined by the input line i#1. Hence, the above described conditions are not satisfied, and the output line o#1 cannot be determined with respect to the input line i#0. In addition, although the input line i#2 waits for the scheduling request of the output line o#3, the input line i#2 is already determined, and thus, the above described conditions are not satisfied. Therefore, it is not possible to determine any line in this second priority process. Similarly, the above described conditions are not satisfied for any of the lines in the third priority process. In the fourth priority process, the above described conditions are satisfied for the output line o#3 of the input line i#0, and it is hence possible to determine the output line o#3.

As a result, the scheduling result of the scheduling in the scheduling cycle C#1 becomes as follows. That is, the input line i#0 is connected to the output line o#3, the input line i#1 is connected to the output line o#1, the input line i#2 is connected to the output line o#2, and the input line i#3 is not connected and no read-out is possible therefrom.

Next, a description will be given of the updating process for updating the highest priority input line. The highest priority input line is updated by selecting the input line having the scheduling request with priority, based on the information indicating the existence of the scheduling request after completion of the scheduling. In this particular case, a search is started from {(present highest priority input line)+1} MOD N, and the input line having the first detected scheduling request is regarded as the next highest priority input line. In the scheduling cycle C#1 shown in FIG. 7, the present highest priority input line is the input line i#2, the search is started from the input line i#3 (i#(2+1)), and the scheduling request is first detected in the input line i#3. Hence, the input line i#3 is regarded as the next highest priority input line. In FIG. 7 and FIGS. 8 through 10 which will be described later, the updated portion is underlined so as to clearly indicate the existence of pointer updating.

If no scheduling request is found in all of the input lines, {(present pointer value)+1} MOD N may be regarded as the next highest priority input line or, the present highest priority input line may be maintained as the next highest priority input line. In FIG. 7, the next highest priority input line is determined from {(present pointer value)+1} MOD N, but it is of course possible to determine the next highest priority input line by any method as long as the line having the scheduling request is selected with priority. In addition, instead of determining the highest priority input line depending on the existence of the scheduling request, it is also possible to uniformly select each of the lines by a simple round-robin format.

Next, a description will be given of the updating process for updating the highest priority output line of each input line. In order to make unbiased scheduling of a plurality of output lines with respect to each input line, the highest priority output line is updated independently with respect to each input line, based on the scheduling result of each input line and the existence of the scheduling request. There generally are the following two updating logics for carrying out this updating process.

According to a first updating logic, when the scheduling request exists in the present highest priority output line during the scheduling and this highest priority output line cannot be determined, the present highest priority output line number is held regardless of the output line number of the output line which is determined.

According to a second updating logic, when the scheduling request exists in the present highest priority output line during the scheduling and this highest priority output line is determined or, when no scheduling request exists in the present highest priority output line during the scheduling and one of the output lines is determined, the search is started from {(determined output line number)+1} MOD N, and the output line having the first detected scheduling request is regarded as the next highest priority output line.

If no scheduling request is found in all of the output lines, {(present highest priority output line number)+1} MOD N may be regarded as the next highest priority output line or, the present highest priority output line may be maintained as the next highest priority output line.

When the above updating process for updating the highest priority output line of each input line is described with reference to FIG. 7, no scheduling request exists in the present highest priority output line o#0 of the input line i#0, and the output line o#3 is determined. Hence, the search is started from the output line o#0 which is obtained from [{defined output line number (o#3)}+1] MOD N, and the output line o#1 having the first detected scheduling request is regarded as the next highest priority output line. On the other hand, the scheduling request exists in the present highest priority output line o#3 of the input line i#1 and in the present highest priority output line o#1 of the input line i#3, and these output lines o#3 and o#1 cannot be determined. Thus, the present highest priority output line o#3 of the input line i#1 is maintained as the next highest priority output line of the input line i#1, and the present highest priority output line o#1 of the input line i#3 is maintained as the next highest priority output line of the input line i#3. In other words, the highest priority output lines of the input lines i#1 and i#3 are not updated. Moreover, the scheduling request exists in the present highest priority output line o#2 of the input line i#2, and this output line o#2 is determined. Accordingly, the search is started from the output line o#0 which is obtained from [{defined output line number (o#2)}+1] MOD N, and the output line o#3 having the first detected scheduling request is regarded as the next highest priority output line.

In this embodiment, the next highest priority output line is determined from [{defined output line number}+1] MOD N, however, any method may be used as long as the output line having the scheduling request is selected with priority. In addition, instead of skipping the output line having no scheduling request, it is possible to select each of the output lines by a simple control employing the round-robin format.

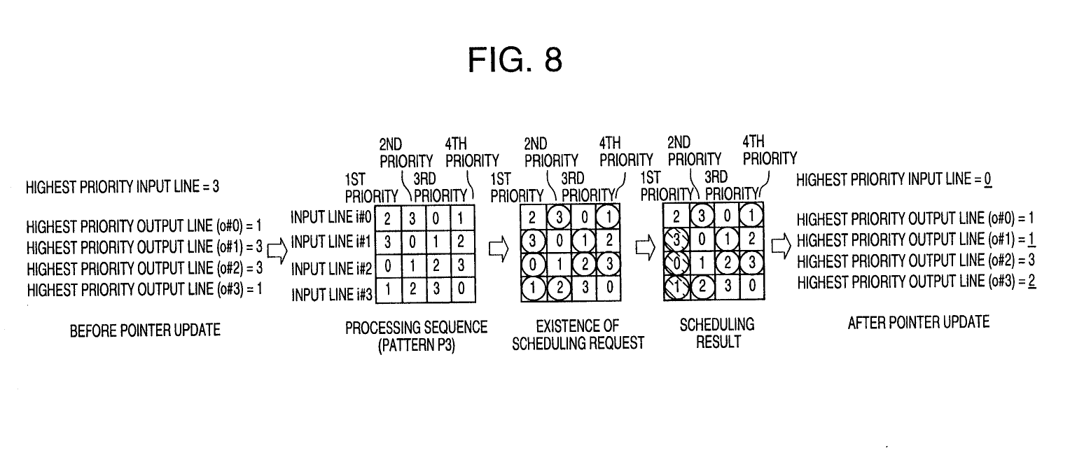

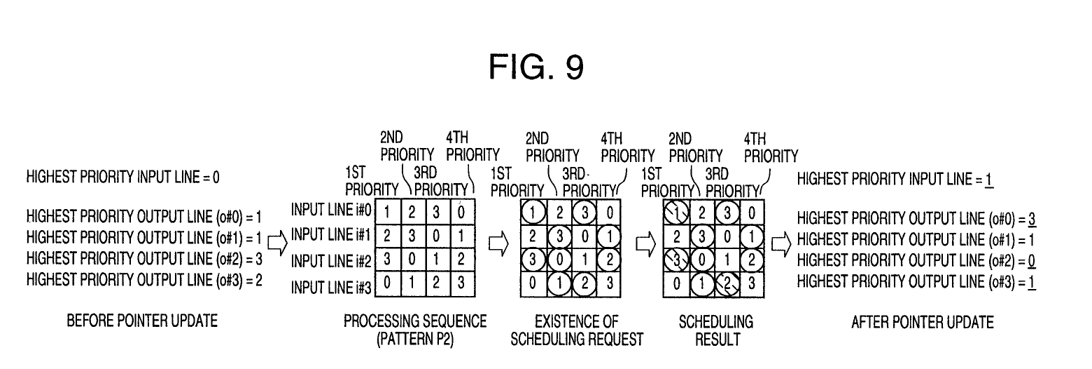

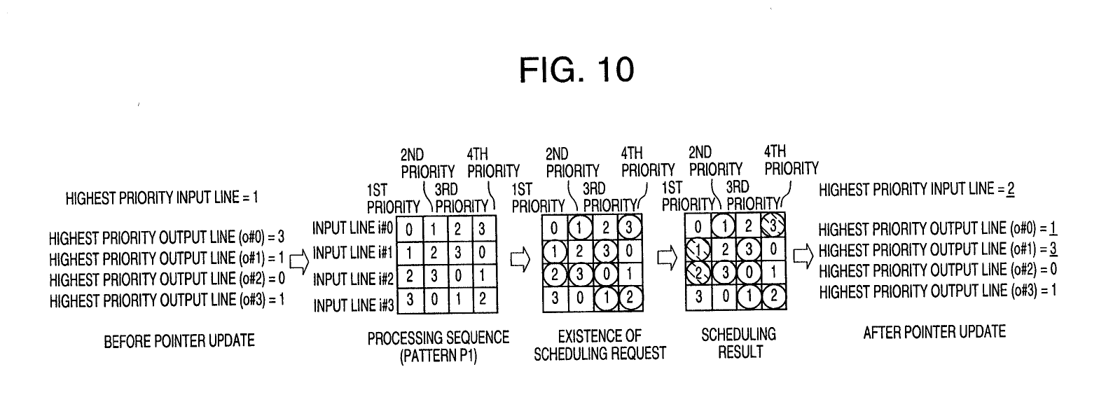

In the scheduling cycle C#2 shown in FIG. 8, the scheduling is carried out by a process similar to the above according to the sequential pattern P#3 which processes the input line i#3 and the output line o#1 with the first priority, responsive to the result of updating the highest priority line in the scheduling cycle C#1. In addition, in the scheduling cycle C#3 shown in FIG. 9, the scheduling is carried out by a process similar to the above according to the sequential pattern P#2 which processes the input line i#0 and the output line o#1 with the first priority, responsive to the result of updating the highest priority line in the scheduling cycle C#2. Moreover, in the scheduling cycle C#4 shown in FIG. 10, the scheduling is carried out by a process similar to the above according to the sequential pattern P#1 which processes the input line i#1 and the output line o#1 with the first priority, responsive to the result of updating the highest priority line in the scheduling cycle C#3.

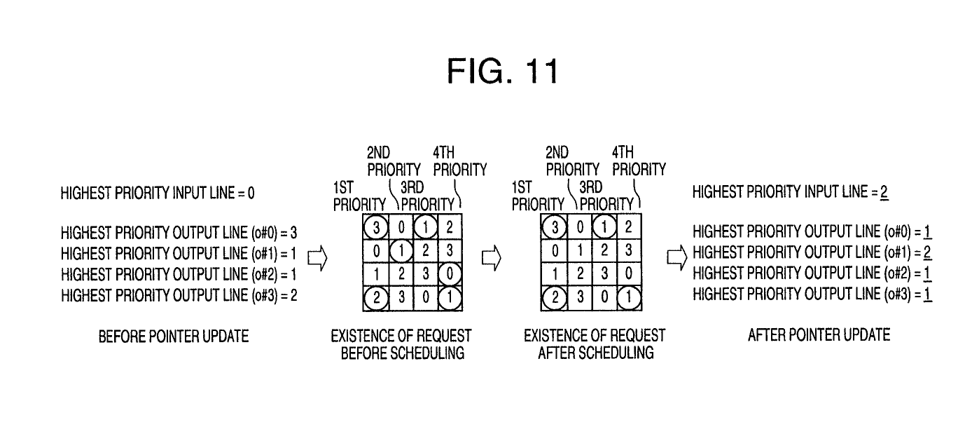

In this embodiment, it is assumed for the sake of convenience that two or more scheduling requests exist for the line to which the scheduling request is presently made, that the existence of the scheduling request does not change before and after the scheduling, and that all of the input lines have the scheduling request. Next, a description will be given of the updating process for updating the highest priority input line for a case shown in FIG. 11 where the existence of the scheduling request changes before and after the scheduling, and the number of scheduling requests of a certain input line becomes zero.

FIG. 11 is a diagram for explaining the updating process of the highest priority input line for the case where the state of existence of the scheduling request is different before and after the scheduling. In FIG. 11, the left half portion indicates the state of existence of the scheduling request before the scheduling during a certain scheduling cycle, and the right half portion indicates the state of existence of the scheduling request after the scheduling during the certain scheduling cycle. In this particular case, the input line i#1 and the output line o#1 and the input line i#2 and the output line o#0 are determined by the present scheduling process, the number of scheduling requests is decremented for each line, and the number of scheduling requests becomes zero for each line, as shown in FIG. 11.

The updating process of the highest priority input line starts the search from {(present highest priority input line)+1} MOD N as described above, and selects the input line having the first detected scheduling request. In other words, the search is started from the input line i#1 which is obtained from [{input line number i#0}+1 MOD N(=1), and the input line i#3 having the first detected scheduling request is regarded as the highest priority input line. Further, [{determined output line number}+1] is regarded as the output line number of the next highest priority output line by the updating process of the highest priority output line with respect to the input lines i#1 and i#2 for which the number of scheduling request becomes zero after the scheduling.

Therefore, by carrying out the scheduling according to the sequence with which the highest priority output line of the highest priority input line is processed with the first priority, for every scheduling cycle, if another input line is the highest priority input line, the scheduling may be carried out with respect to an output line which is other than the output line which is originally to be processed with the highest priority with respect to a certain input line. But even in such a case, when this certain input line becomes the highest priority input line, it is always possible to carry out the scheduling of the highest priority output line of this certain input line. For this reason, although one of two specific input lines is always selected with priority according to the conventional method, the above described process of this embodiment enables the scheduling of the output lines of each of the input lines to be carried out in an unbiased manner, thereby making it possible to carry out an efficient scheduling.

Next, a description will be given of a second embodiment of the scheduling method according to the present invention which schedules a priority line with priority. In a case where the rates of traffic from one input line to different output lines greatly differ, the throughput of an output line having a high load may deteriorate when each of the output lines is uniformly selected as in the first embodiment described above. In order to avoid such a deterioration of the throughput, it is conceivable to select each of the output lines depending on the load thereof, but it is difficult to switch the selection logic at a high speed by following the load which changes dynamically. On the other hand, a more simple approach which is conceivable is to monitor the number of remaining packets for every predetermined period, and to judge that a VOQ (that is, a line having a high load) in which the remaining packets exist is a priority line. In this case, the priority line can be selected with priority during the scheduling, so as to schedule each of the output lines in an unbiased manner depending on the load.

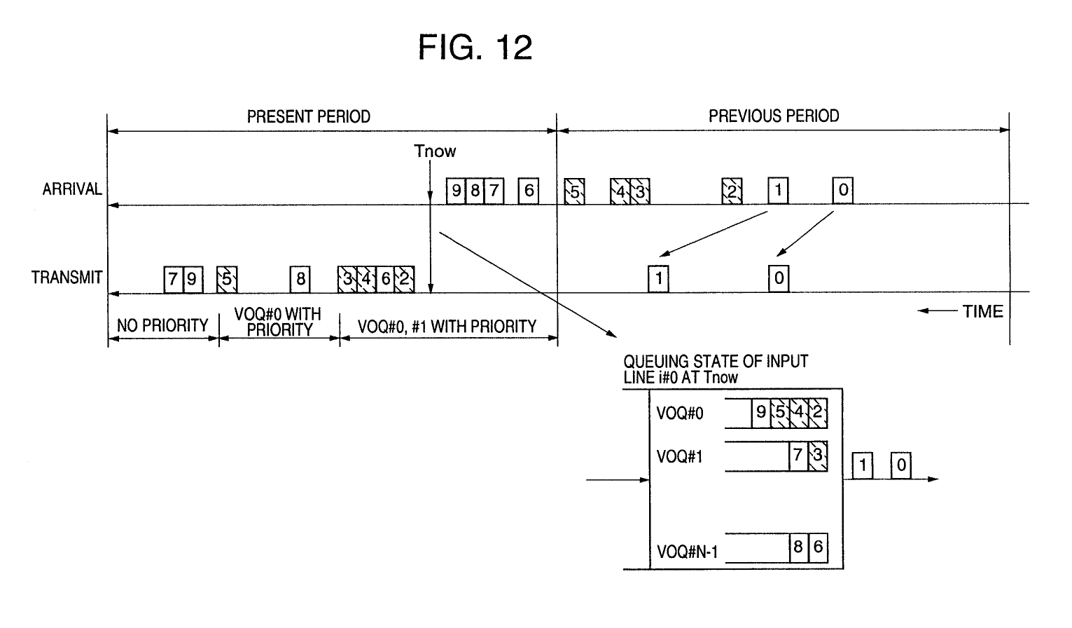

FIG. 12 is a diagram for explaining the process of this second embodiment of the scheduling method according to the present invention. More particularly, FIG. 12 shows the flow of arriving packets and transmitting packets for a certain input line. Packets having sequence numbers (SNs) 0 through S arrive during the previous predetermined period (previous period), and only the packets having the sequence numbers 0 and 1 are transmitted within the previous period. In addition, the packets having the sequence numbers 6 through 9 arrive during the present period. A judgement process to determine whether a line is a priority line or a non-priority line is made at a last time, that is, at the end of the predetermined period. The judgement process regards the output line in which the packet remains as the priority line, and regards the line in which no packet remains as the non-priority line.

In addition, the priority and non-priority lines are judged and the number of remaining packets therein is held. At a last time of the previous period, there are 3 remaining packets in the VOQ#0 and 1 remaining packet in the VOQ#1, and thus, these values are held. These values are reduced when the remaining packets are transmitted in the next period, and the output line is regarded as a non-priority line when the value becomes zero (the non-priority line constantly remains as a non-priority line during the next period). In FIG. 12, the packet with the hatching indicates a packet arrived during the previous period, and the packet without the hatching indicates a packet arrived during the present period. The packets remaining in the input buffer section of the input line i#0 at a time Tnow are as shown on the bottom portion of FIG. 12.

The above described priority output line is scheduled with priority when carrying out the scheduling process. In other words, in the present period, the VOQ#0 and the VOQ#1 which are priority lines are selected with priority over other VOQs. For this reason, in the present period, the packet of the VOQ#0 which is a priority line and has the sequence number 2 is transmitted. Next, the packet of the VOQ#N−1 which is a non-priority line and has the sequence number 6 is transmitted, because although an attempt is made to select the VOQ#0 and the VOQ#1 with priority, the VOQ#0 and the VOQ#1 are already scheduled by another input line and the VOQ#N−1 which is a non-priority line is selected instead. Similarly thereafter, the priority line is selected with priority, and the packets of the VOQ#0 (sequence number 4) and the VOQ#1 (sequence number 3) are next transmitted. At a time when the packet having the sequence number 3 is transmitted, the packets of the VOQ#1 arrived during the previous period are all read, and thus, the VOQ#1 is then regarded as a non-priority line and only the VOQ#0 becomes the priority line thereafter.

Similar processes are repeated, and at a time when the last packet of the VOQ#0 (sequence number 5) arrived during the previous period is transmitted, all of the output lines become non-priority lines. Hence, the output line having a remaining packet is judged for every predetermined period, and the output line having the remaining packet is selected with priority until no packet arrived during the previous period remains. As a result, the output line having a large load is selected with priority, and it is possible to carry out the scheduling depending on the load even when the traffic is not uniform among the lines.

Next, a description will be given of a process of scheduling the priority line described above with priority. The scheduling in this case can be realized by any of the following three processing methods.

According to a first processing method, the scheduling is carried out collectively with respect to the lines in which the scheduling request exists, regardless of whether the lines are priority lines or non-priority lines. A priority line is regarded as a next highest priority output line with priority over non-priority lines when updating the highest priority line.

According to a second processing method, the scheduling is carried out by constantly processing the priority lines with priority over non-priority lines.

According to a third processing method, the scheduling is carried out by processing the priority lines and the non-priority lines in parallel.

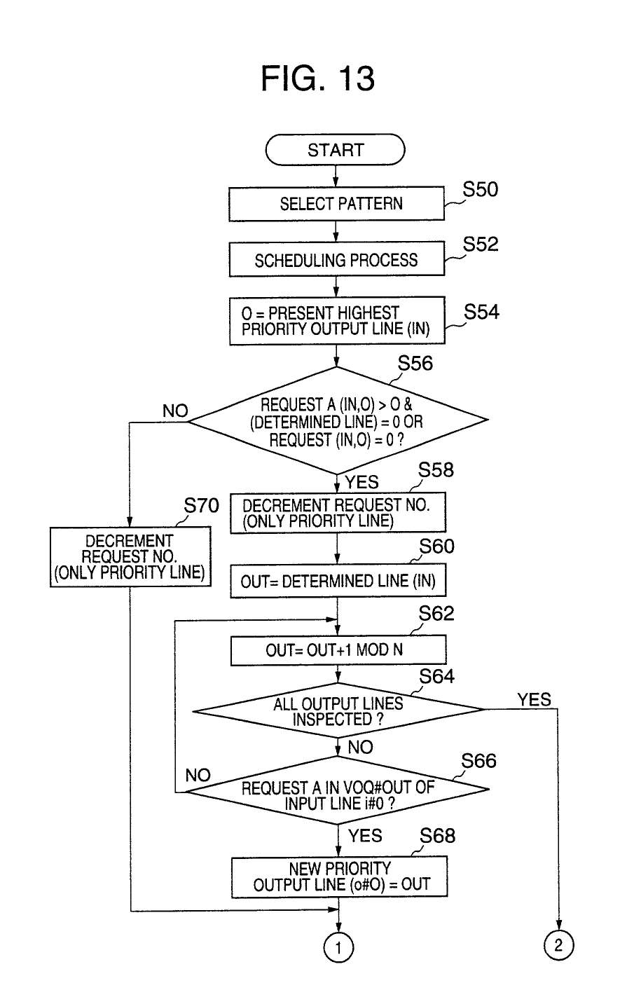

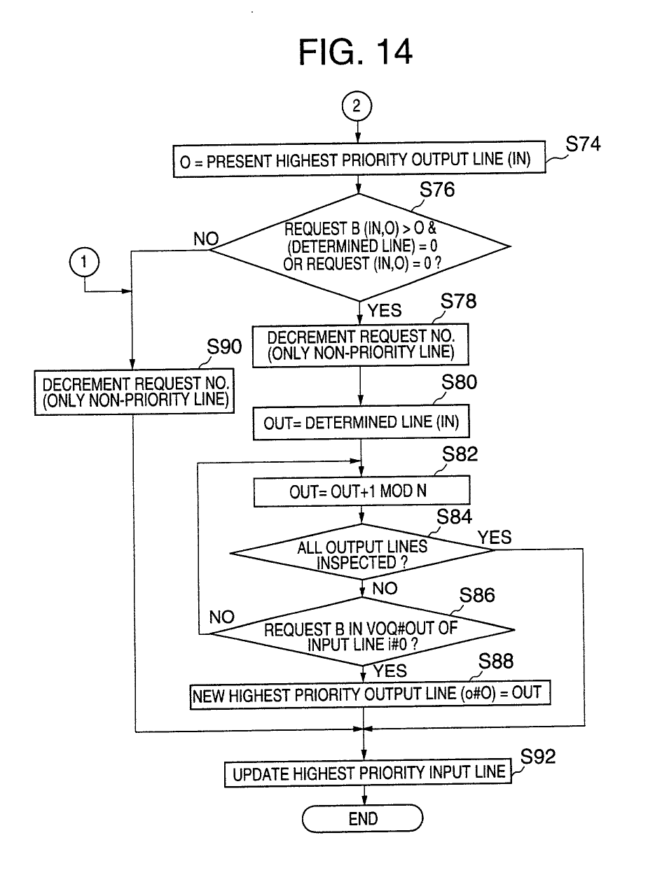

FIGS. 13 and 14 are flow charts for explaining a priority scheduling collective process of this second embodiment of the scheduling method, that is, the first processing method. A scheduling request A is output when a packet arrived during the previous period exists, and a scheduling request B is output when a packet arrived during the present period exists. A scheduling request A(IN, O) indicates the number of requests arrived during the previous period of the VOQ#0 for the input line i#IN, and a scheduling request B(IN, O) indicates the number of request arrived during the present period of the VOQ#0 for the input line i#IN.

In FIG. 13, a step S50 selects a pattern which processes the highest priority output line of the highest priority input line with the first priority. Then, a step S52 carries out a scheduling process according to the processing sequence of the selected pattern. Steps S54 through S70 are carried out thereafter for every input line.

The step S54 stores the highest priority input line of the present input line IN to O. The step S56 decides whether or not the request A(IN, O)>0 and the determined line is O or, whether or not the request A(IN, O)=0. The process advances to the step S58 if the decision result in the step S56 is YES, and the process advances to the step S70 if the decision result in the step S56 is NO.

The step S58 decrements the number of requests of the determined line by one, with respect to only the priority line. The step S60 stores the determined line of the input line i#IN to OUT. The step S62 computes OUT+1 MOD N, and stores the computed result in OUT. The step S64 decides whether or not all of the output lines are inspected. If the decision result in the step S64 is NO, the step S66 decides whether or not the request A exists in the VOQ#OUT of the input line i#0.

The process returns to the step S62 if the decision result in the step S66 is NO, the step S68 sets newly sets the line number stored in OUT as the line number of the highest priority output line stored in O, and the process advances to a step S74 shown in FIG. 14 if the decision result in the step S66 is YES. In addition, the process also advances to the step S74 if the decision result in the step S64 is YES. On the other hand, if the decision result in the step S56 is NO, the step S70 decrements the number of requests of the determined line by one, with respect to only the priority line, and the process thereafter advances to the step S74.

In FIG. 14, steps S74 through S90 are carried out for every input line. The step S74 stores he highest priority output line of the present input line IN to O. Then, the step S76 decides whether or not the request B(IN, O)>0 and the determined line is O or, whether or not the request B(IN, O)=0. The process advances to the step S78 if the decision result in the step S76 is YES, and the process advances to the step S90 if the decision result in the step S76 is NO.

The step S78 decrements the number of requests of the determined line by one, only with respect to the non-priority line. The step S80 stores the determined line of the input line i#IN to OUT, and the step S82 computes OUT+1 MOD N and stores the computed result in OUT. The step S84 decides whether or not all of the output lines are inspected. If the decision result in the step S84 is NO, the step S86 decides whether or not the request B exists in the VOQ#OUT of the input line i#O.

The process advances to the step S82 if the decision result in the step S86 is NO. If the decision result in the step S86 is YES, the step S88 newly sets the line number stored in OUT as the line number of the highest priority output line stored in O, and the process advances to a step S92. In addition, the process also advances to the step S92 if the decision result in the step S84 is YES. On the other hand, if the decision result in the step S76 is NO, the step S90 decrements the number of requests of the determined line by one, with respect to only the non-priority line, and the process thereafter advances to the step S92. The step S92 updates the present highest priority input line, and the process ends.

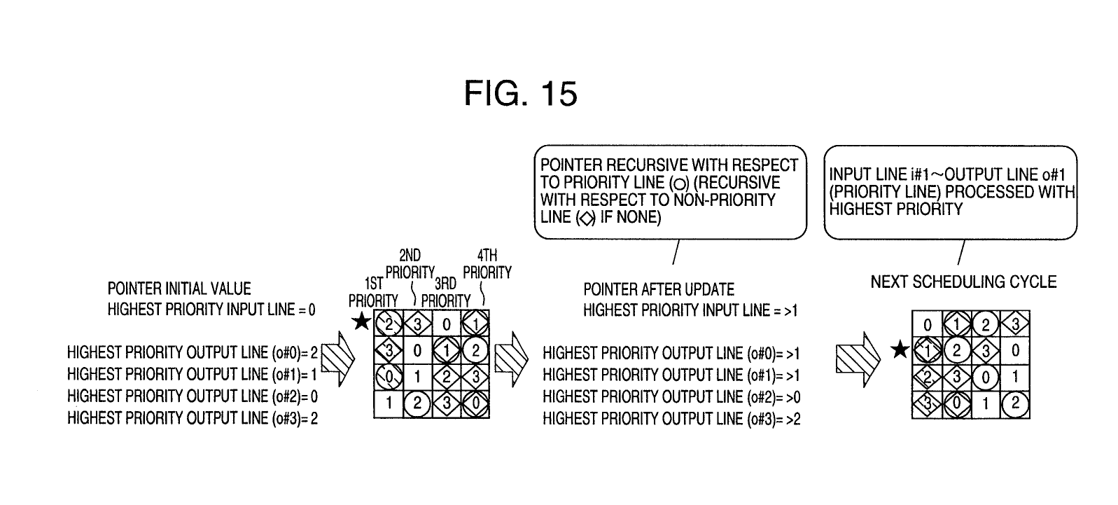

FIG. 15 is a diagram for explaining an example of an operation of the priority scheduling collective process. In FIG. 15, a circular mark indicates that a packet (request) arrived during the previous period exists, a diamond mark indicates that a packet arrived during the present period exists, a combination of the circular and diamond marks indicates that both the packet arrived during the previous period and the packet arrived during the present period exist, and the output line with a star mark indicates a priority output line. In other words, the output lines with the circular mark or with the combination of both the circular and diamond marks are priority output lines. However, when carrying out the scheduling process, the priority output lines are not given special attention, and the scheduling is simply carried out with respect to the output lines, with the circular or diamond marks, in which the request exists.

For example, in a first priority process, the request exists in the input lines i#0, i#1 and i#2, and since the input lines i#0, i#1 and i#2 are undetermined, the input lines i#0, i#1 and i#2 become the determined lines. In FIG. 15, the determined lines are indicated by shading. The scheduling process does not need to be aware of the priority and non-priority lines, but selects the priority line with priority when updating the highest priority output line. For example, the output line o#2 is the present highest priority output line of the input line i#0, and since this output line o#2 is the determined line, the search starts from the determined line {(o#2)+1} MOD N (=3), and the first detected priority output line is regarded as the next highest priority output line. In this case, there is no need to judge the existence of a packet because the packet will always exist in the priority output line.

For this reason, the VOQ#1 is selected as the next highest priority output line, and not the VOQ#3 of the non-priority output line. Similarly, the output line o#0 is the determined line with respect to the input line i#2, the search starts from the determined line {(o#0)+1} MOD N (=1), and the first detected priority line (VOQ#0) is regarded as the next highest priority output line. Since the VOQ#0 is the only highest priority output line for the input line i#2, the next highest priority output line is also the VOQ#0.

When the scheduling result of the input line i#1 is observed, the VOQ# of the non-priority line is selected, even though the priority line (VOQ#1, VOQ#2) exists in the input line i#1. However, since the priority line is selected with priority by the highest priority line updating procedure, the priority line is always processed with priority during the cycle in which the input line i#1 is processed with priority, as indicated by “Next Scheduling Cycle” in FIG. 15. The highest priority output line of the input line is not updated in this case because, as described above in conjunction with the first embodiment, a request exists in the present highest priority output line and this line cannot be determined.

Therefore, according to the first processing method, the priority line is not always selected with priority, and at least the priority line is selected with priority when the input line thereof is processed with highest priority. As a result, it is possible to realize both a reduced processing time and a relatively rough priority process.

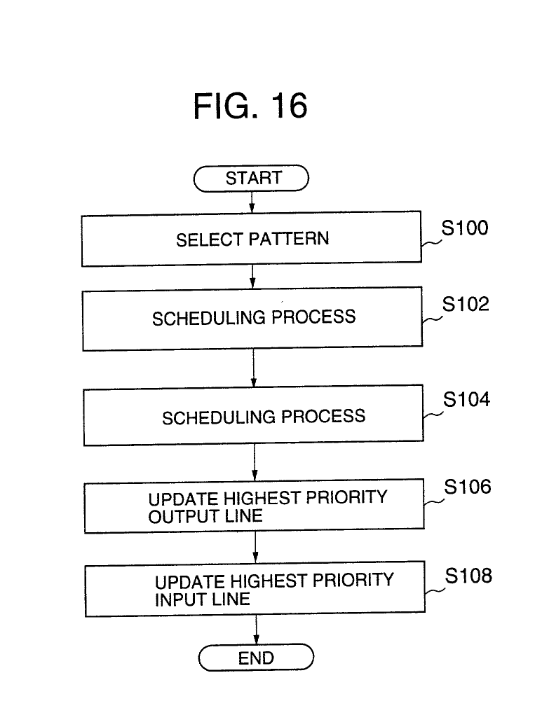

Next, a description will be given of a process of constantly processing the priority line with priority, that is, the second processing method, by referring to FIG. 16. FIG. 16 is a flow chart for explaining a first embodiment of a priority scheduling sequential process. This embodiment of the priority scheduling sequential process is applied to a case where the pointer of the highest priority output line is used in common for the priority line and the non-priority line. In FIG. 16, a step S100 selects a pattern which processes the highest priority output line of the highest priority input line with the first priority. Then, a step S102 carries out a scheduling process according to the processing sequence of the selected pattern. In this case, a VOQ which is the target of the scheduling is only the VOQ having the packet arrived during the previous period.

Thereafter, a step S104 carries out a scheduling process according to the processing sequence of the selected pattern. In this case, however, a VOQ which is the target of the scheduling is all VOQs. Next, a step S106 judges the number of requests (=(request A)+(request B)) of the VOQ#0 for the input line i#IN and updates the highest priority output line, similarly to the steps S54 through S70 shown in FIG. 13. Furthermore, a step S108 updates the highest priority input line, similarly to the steps S74 through S90 shown in FIG. 13, and the process ends.

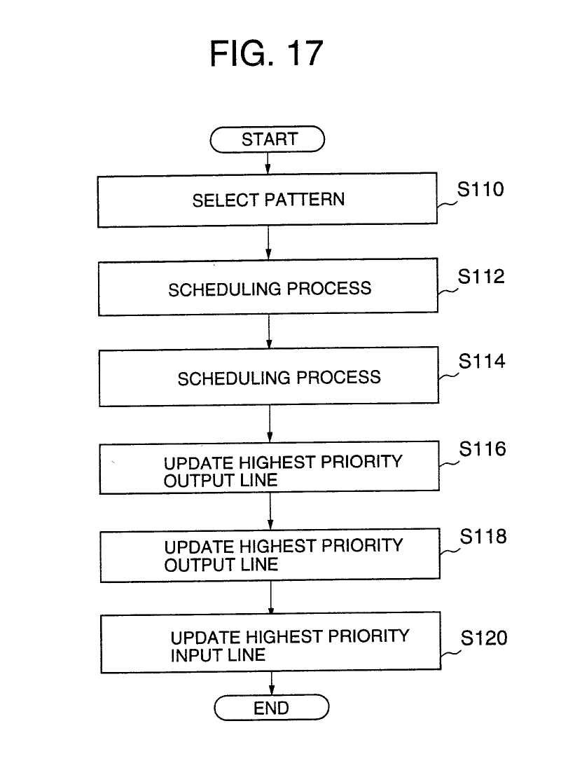

FIG. 17 is a flow chart for explaining a second embodiment of the priority scheduling sequential process, that is, the second processing method. In this embodiment, the pointer of the highest priority output line is independent for the priority line and the non-priority line. In FIG. 17, a step S110 selects a pattern which processes the highest priority output line of the highest priority input line with the first priority. Then, a step S112 carries out a scheduling process according to the processing sequence of the selected pattern. In this case, a VOQ which is the target of the scheduling is only the VOQ having the packet arrived during the previous period.

Next, a step S114 carries out a scheduling process according to the processing sequence of the selected pattern. In this case, a VOQ which is the target of the scheduling is all VOQs. Thereafter, a step S116 judges the request A(IN, O) which is the number of requests arrived during the previous period of the VOQ#0 for the input line i#IN and updates the highest priority output line, similarly to the steps S54 through S70 shown in FIG. 13. A step S118 judges the request B(IN, O) which is the number of requests arrived during the present period of the VOQ#0 for the input line i#IN and updates the highest priority output line, similarly to the steps S54 through S70 shown in FIG. 13. Furthermore, a step S120 updates the highest priority input line, similarly to the steps S74 through S90 shown in FIG. 14, and the process ends.

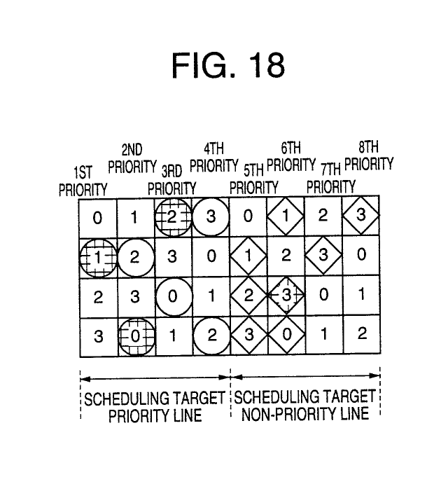

FIG. 18 is a diagram for explaining an example of an operation of the first embodiment of the priority scheduling sequential process. In FIG. 18, a scheduling is first carried out with respect to only the priority lines during a first half (first through fourth priorities) of the scheduling process, and a scheduling is then carried out with respect to the non-priority lines of the lines which are undetermined when processing the priority lines during a second half (fifth through seventh priorities) of the scheduling process. For this reason, it is possible to always schedule the priority lines with priority, regardless of the existence of the request in the non-priority line. However, compared to the first processing method described above, the processing time is doubled. For example, with respect to the input line i#0, the output lines o#2 and o#3 are the priority lines, and the output line o#1 is the non-priority line. In the case of the first processing method, the non-priority line (output line o#1) is selected based on the processing sequence, but according to this second processing method, the priority line is always selected with priority over the non-priority line, and thus, the priority line (output line o#2) can be selected based on the processing sequence.

On the other hand, with respect to the input line i#2, the output line o#0 is the priority line, and the output lines o#2 and o#3 are the non-priority lines. Hence, the output line o#0 which is the priority line is selected with priority. However, when processing the output line o#0, the output line o#0 cannot be determined because the output line o#0 is already determined by the input line i#3. As a result, the output line o#3 which is the non-priority line is determined in this case.

Accordingly, the processing of the non-priority lines is carried out after the processing of the priority lines is carried out for all of the input lines, and the priority lines can be completely scheduled with priority. In addition, an efficient scheduling can be made by utilizing the non-priority line which can be determined when processing the priority line. In the first embodiment, the processing sequences of the priority lines and the non-priority lines are the same, that is, the highest priority input line and the highest priority output line are used in common for the processing of the priority line and the processing of the non-priority line. But in this second embodiment, the highest priority lines are management independently for the processing of the priority line and the processing of the non-priority line. More particularly, the first half of the processing uses the sequence pattern which processes the highest priority input line and the highest priority output line of the priority lines with the first priority, and the second half of the processing uses the sequence pattern which processes the highest priority input line and the highest priority output line of the non-priority lines with the first priority.

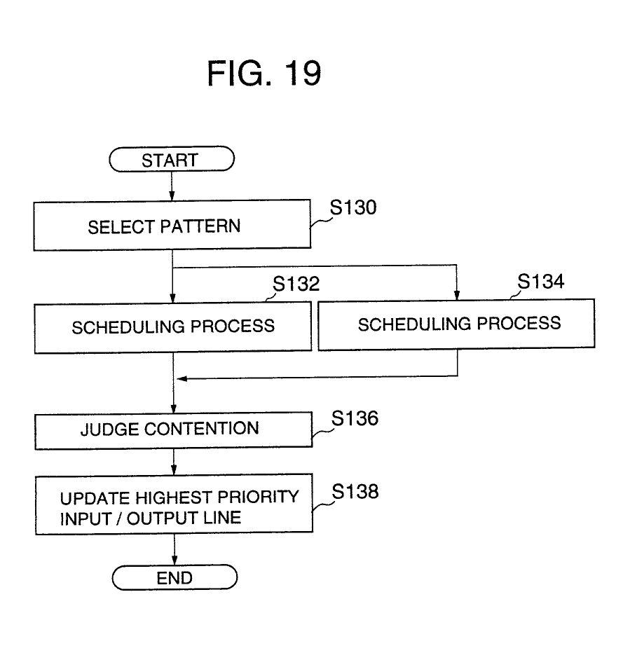

Next, a description will be given of the third processing method which processes the priority line and the non-priority line in parallel. FIG. 19 is a flow chart for explaining a first embodiment of a priority scheduling parallel process, that is, the third processing method. In FIG. 19, a step S130 selects a pattern which processes the highest priority output line of the highest priority input line with the first priority. Then, a step S132 carries out a scheduling process according to a processing sequence of the selected pattern. In this case, a VOQ which is the scheduling target is only the VOQ having the packet arrived during the previous period. A step S134 is carried out in parallel to the step S132. The step S134 carries out a scheduling process according to the processing sequence of the selected pattern. In this case, a VOQ which is the scheduling target is all VOQs.

A step S136 judges a contention between the scheduling result of the step S132 and the scheduling result of the step S134, and selects the scheduling result on the priority line side, that is, the scheduling result of the step S132, if the contention is generated. Thereafter, a step S138 judges the request A(IN, O) which is the number of requests arrived during the previous period of the VOQ#0 for the input line i#IN and updates the highest priority output line, similarly to the steps S54 through S70 shown in FIG. 13. The step also judges the request B(IN, O) which is the number of requests arrived during the present period of the VOQ#0 for the input line i#IN and updates the highest priority output line, similarly to the-steps S54 through S70 shown in FIG. 13. Furthermore, the step S138 updates the highest priority input line, similarly to the steps S74 through S90 shown in FIG. 14, and the process ends. The step S138 may collectively process the priority line and the non-priority line.

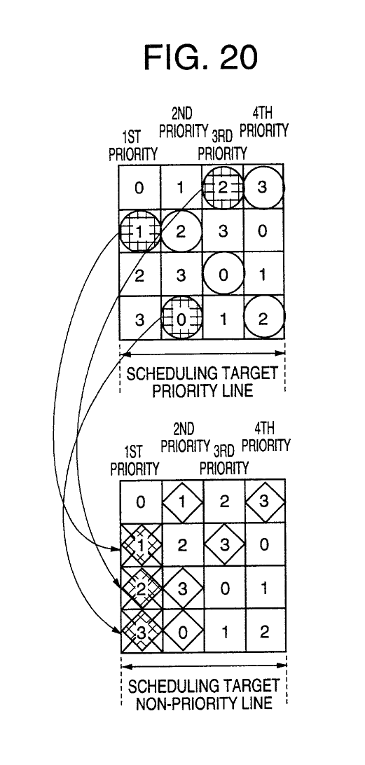

FIG. 20 is a diagram for explaining an example of an operation of the first embodiment of the priority scheduling parallel process. Two temporary scheduling results shown in FIG. 20 are obtained by carrying out the scheduling of the priority line and the non-priority line in parallel. Then, a judgement is made to determine whether or not a contention exists between the two scheduling results. In this particular example, the VOQ#1 is selected by the input line i#1 of the priority line side and by the input line i#1 of the non-priority line side, and the VOQ#2 is selected by the input line i#0 of the priority line side and by the input line i#2 of the non-priority line side. In addition, the VOQ#0 is selected by the input line i#3 of the priority line side, and the VOQ#3 is selected by the input line i#3 of the non-priority line side. Hence, different VOQs are selected by the same input line.

Accordingly, when selecting the same output line by the different input lines between the priority line and the non-priority line or, when selecting the different VOQs by the same input line or, when selecting the same VOQ by the different input lines, the scheduling result of the priority line side is used, and the determined state of the non-priority line side with contention is invalidated. In FIG. 20, the invalidated state is indicated by a mark “X”. By carrying out the scheduling of the priority line and the non-priority line in parallel in this manner, it is possible to reduce the processing time of the scheduling. Furthermore, by invalidating the scheduling result of the non-priority line side upon contention, it is possible to avoid the contention and schedule the priority line with priority.

In this embodiment, the processing sequence of the two scheduling processes which are carried out in parallel is also the same for the priority line and the non-priority line. However, it is possible to independently manage the highest priority line by the two scheduling processes, and the processing sequence may be independently set for the two scheduling processes. In addition, although this embodiment judges the contention collectively after the scheduling, it is of course possible to judge the contention for every priority process. Moreover, for the two scheduling processes which are carried out in parallel with respect to the priority line and the non-priority line in this embodiment, it is of course possible to use a plurality of priorities.

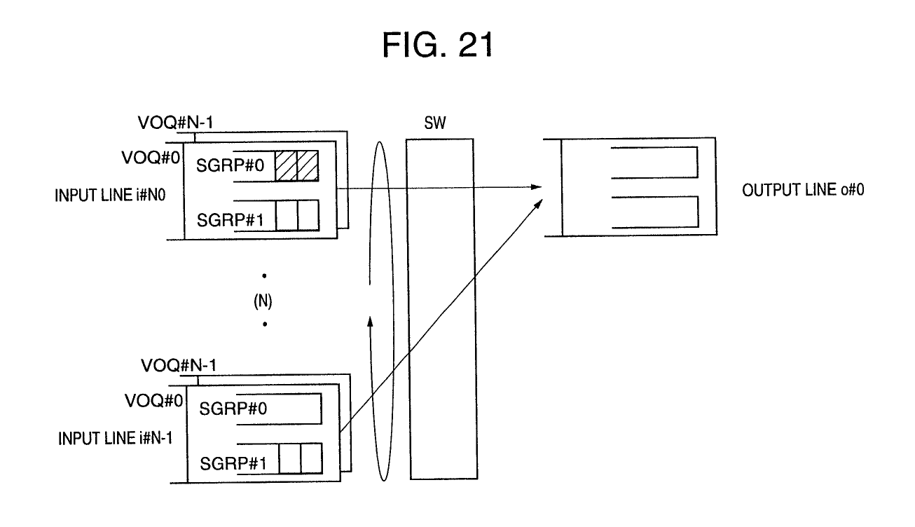

In the second embodiment described above, the priority line is selected with priority within the same input line. Next, a description will be given of a third embodiment of the priority scheduling sequential process which selects the priority line with priority between different input lines. FIG. 21 is a diagram for explaining this third embodiment of the priority scheduling sequential process.

An example of such a selection occurs in a switch which has a plurality of Quality of Services) QoSs within one output line (VOQ), when the input line having a packet of a high priority class or group is to be scheduled with priority. For example, if the input line i#0 has a packet of a high priority group SGRP#0 addressed to the output line o#0, and the input line i#N−1 has a packet of a low priority group SGRP#1 addressed to the output line o#0 as shown in FIG. 21, the input line i#0 having the packet of the high priority group SGRP#0 is scheduled with priority.

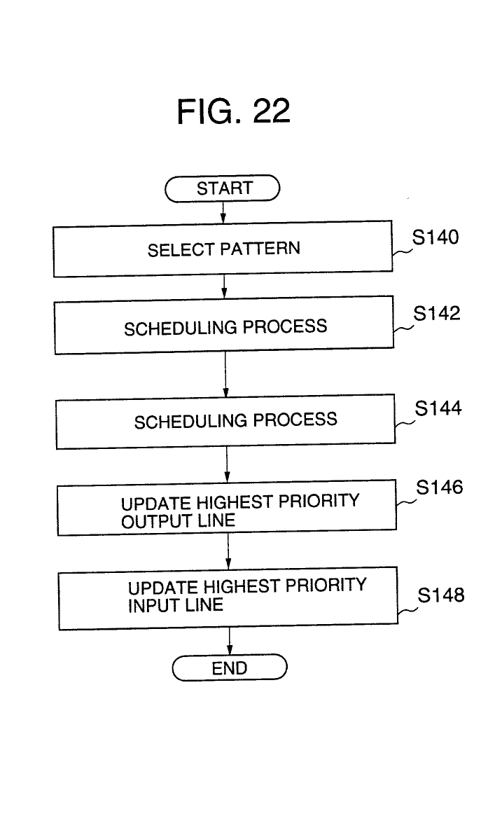

FIG. 22 is a flow chart for explaining this third embodiment of the priority scheduling sequential process. In this embodiment, the point of the highest priority output line is common to the high priority group and the low priority group. In FIG. 22, a step S140 selects a pattern which processes the highest priority output line of the highest priority input line with the first priority. Then, a step S142 carries out a scheduling process according to a processing sequence of the selected pattern. In this case, a VOQ which is the scheduling target is only the VOQ having the packet of the high priority group SGRP.

Next, a step S144 carries out a scheduling process according to a processing sequence of the selected pattern. In this case, a VOQ which is the scheduling target is all VOQs. A step S146 judges a request QT(IN, O) which is the number of requests (=(request QA)+(request QB)) of the VOQ#0 for the input line i#IN, similarly to the steps S54 through S70 shown in FIG. 13, and updates the highest priority output line. The request QA(IN, O) is the number of requests of the high priority group of the VOQ#0 for the input line i#IN, and the request QB(IN, O) is the number of requests of the low priority group of the VOQ#0 for the input line i#IN. Then, a step S148 updates the highest priority input line, similarly to the steps S74 through S90 shown in FIG. 14, and the process ends.

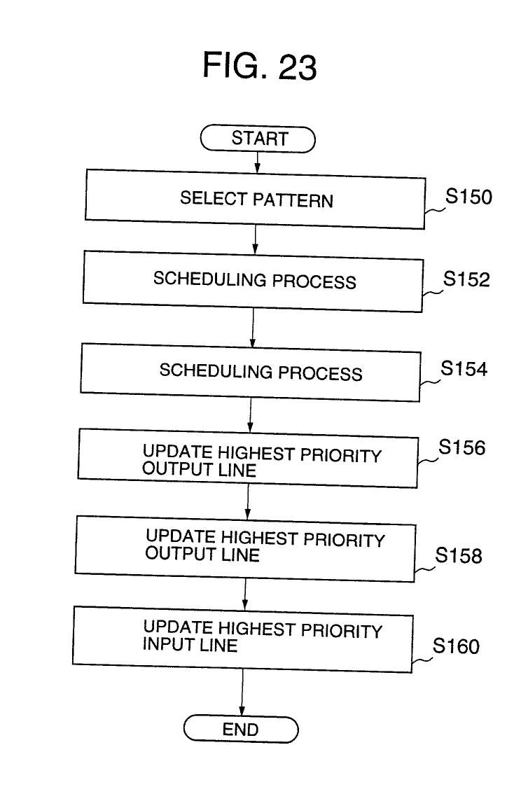

FIG. 23 is a flow chart for explaining a fourth embodiment of the priority scheduling sequential process. In this embodiment, the pointer of the highest priority output line is independent for the high priority group and the low priority group. In FIG. 23, a step S150 selects a pattern which processes the highest priority output line of the highest priority input line with the first priority. Then, a step S152 carries out a scheduling process according to a processing sequence of the selected pattern. In this case, a VOQ which is the scheduling target is only the VOQ having the packet of the high priority group.

Next, a step S154 carries out a scheduling process according to a processing sequence of the selected pattern. In this case, a VOQ which is the scheduling target is all VOQs. A step S156 judges a request QA(IN, O) which is the number of requests of the high priority group of the VOQ#0 for the input line i#IN, similarly to the steps S54 through S70 shown in FIG. 13, and updates the highest priority output line. A step S158 judges a request QB(IN, O) which is the number of requests of the low priority group of the VOQ#0 for the input line i#IN, similarly to the steps S54 through S70 shown in FIG. 13, and updates the highest priority output line. Then, a step S160 updates the highest priority input line, similarly to the steps S74 through S90 shown in FIG. 14, and the process ends.

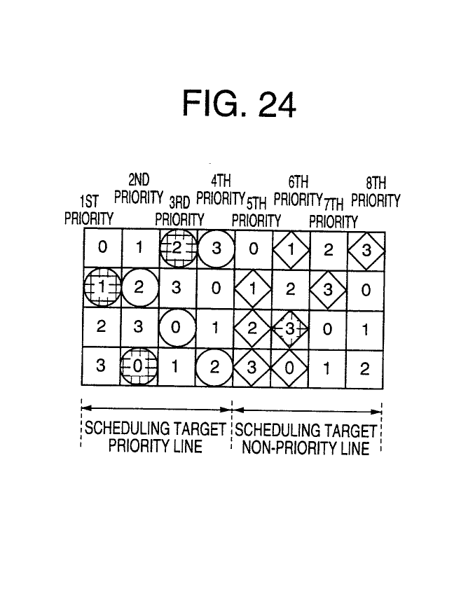

FIG. 24 is a diagram for explaining an example of an operation of this third embodiment of the priority scheduling sequential process. In FIG. 24, a scheduling is carried out only with respect to the line having the request of the high priority group of the high priority lines during a first half of the scheduling process (first through fourth priorities), and a scheduling is carried out with respect to the line having the request of the low priority group with respect to the undetermined lines during a second half of the scheduling process (fifth through eighth priorities). Hence, it is possible to schedule the high priority group completely with priority, and to transmit the packet of the low priority group by effectively utilizing a vacant band.

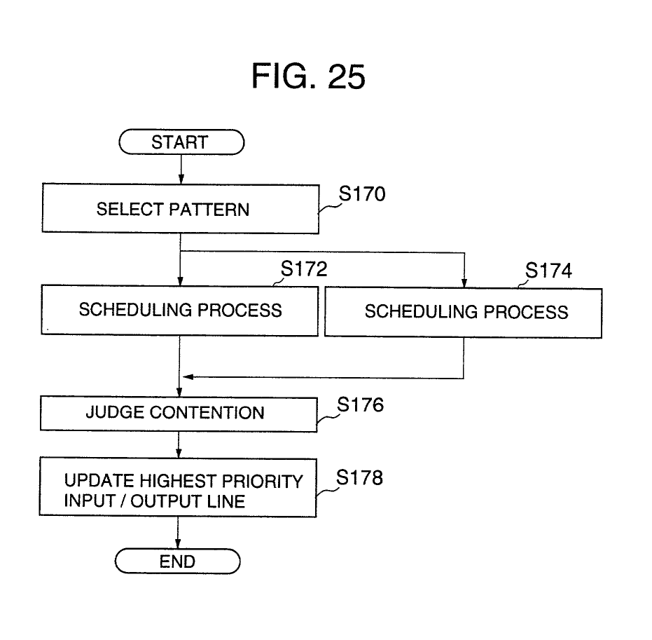

FIG. 25 is a flow chart for explaining a second embodiment of the priority scheduling parallel process. In FIG. 25, a step S170 selects a pattern which processes the highest priority output line of the highest priority input line with the first priority. Then, a step S172 carries out a scheduling process according to a processing sequence of the selected pattern. In this case, a VOQ which is the scheduling target is only the VOQ having the packet of the high priority group. A step S174 carries out a scheduling process according to a processing sequence of the selected pattern, in parallel to the step S172. In the case of the scheduling process of the step S174, a VOQ which is the scheduling target is all VOQs.

A step S176 judges contention between the scheduling result of the step S172 and the scheduling result of the step S174, and selects the high priority group side, that is, the scheduling result of the step S172 if the contention is generated. Thereafter, a step S178 judges a request QA(IN, O) which is the number of requests of the high priority group of the VOQ#0 for the input line i#IN and updates the highest priority output line, similarly to the steps S54 through S70 shown in FIG. 13. The step S178 also judges a request QB(IN, O) which is the number of requests of the low priority group of the VOQ#0 for the input line i#IN and updates the highest priority input line, similarly to the steps S74 through S90 shown in FIG. 14, and the process ends. The step S178 may collectively process the priority line and the non-priority line.

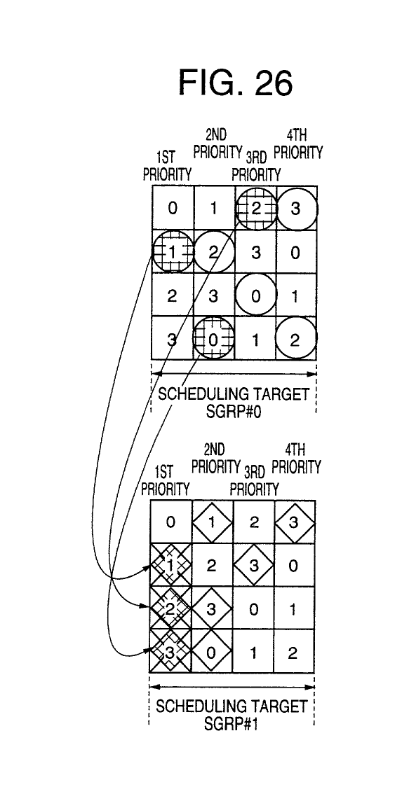

FIG. 26 is a diagram for explaining an example of an operation of this second embodiment of the priority scheduling parallel process. Two temporary scheduling results shown in FIG. 26 are obtained by carried out the scheduling of the high priority group and the low priority group in parallel. Then, a judgement is made to determine whether or not a contention exists between the two temporary scheduling results. In this particular case, the input line i#1 of the high priority group and the input line i#1 of the low priority group select the same VOQ#1, and the input line i#0 of the high priority group and the input line i#2 of the low priority group select the same VOQ#2. Furthermore, the input line i#0 of the high priority group and the input line i#2 of the low priority group select the same VOQ#2. The input line i#3 of the high priority group selects the VOQ#0, and the input line i#3 of the low priority group selects the VOQ#3. In other words, the same input line selects different VOQs.

When the two processing methods of FIG. 22 (or FIG. 23) and FIG. 25 are used, it is possible to read the packet of the high priority group with priority for all of the lines. For example, in a case where a best effort traffic is assigned to the low priority group, it is possible to transmit the packet of the high priority group without being affected by random best effort traffic.

The processing sequence may be varied between the high priority group and the low priority group. In addition, the high priority group and the low priority group may be collectively processed, and the line having the request of the high priority group may be regarded as the next highest priority output line with priority when updating the highest priority output line. But in this case, it is not possible to schedule the high priority group completely with priority, and the high priority group may be affected by the low priority group.

Furthermore, it is possible to combine the priority line scheduling of the second embodiment and the priority group scheduling of the third embodiment. For example, in the case of the collectively processing method, the priority group process may be carried out by a sequential process, and the priority line process may be carried out by a collective process. In addition, in the case of the sequential processing method, the process may be carried out in a sequence of “high priority group, priority line”, “high priority group, non-priority line”, “low priority group, priority line”, and “low priority group, non-priority line”. Moreover, in the case of the parallel processing method, the four kinds of sequential processes described above may be carried out in parallel. Of course, combinations other than those described above may be employed, and the number of priority groups and the number of priority lines are not limited to certain values.

Next, a description will be given of a fourth embodiment of the scheduling method according to the present invention in which the correspondences of the input lines and the output lines are switched from those of the first through third embodiments described above.

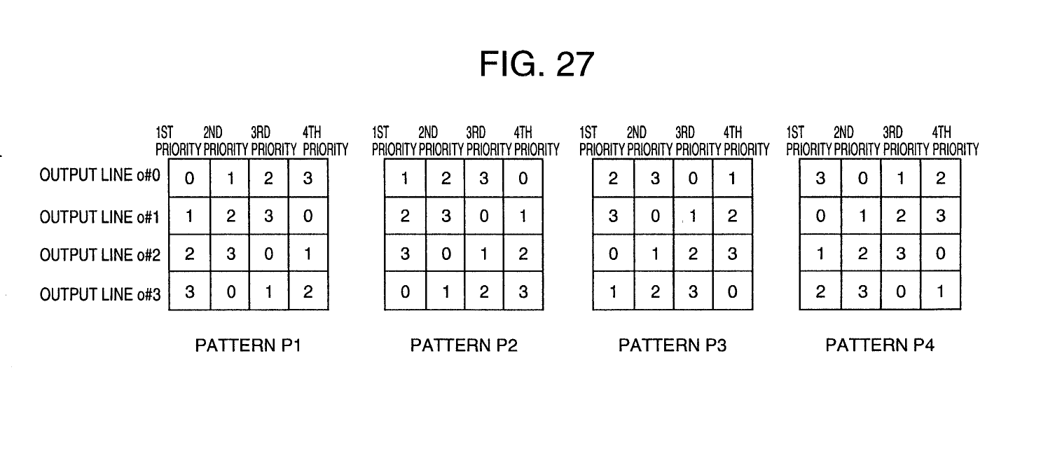

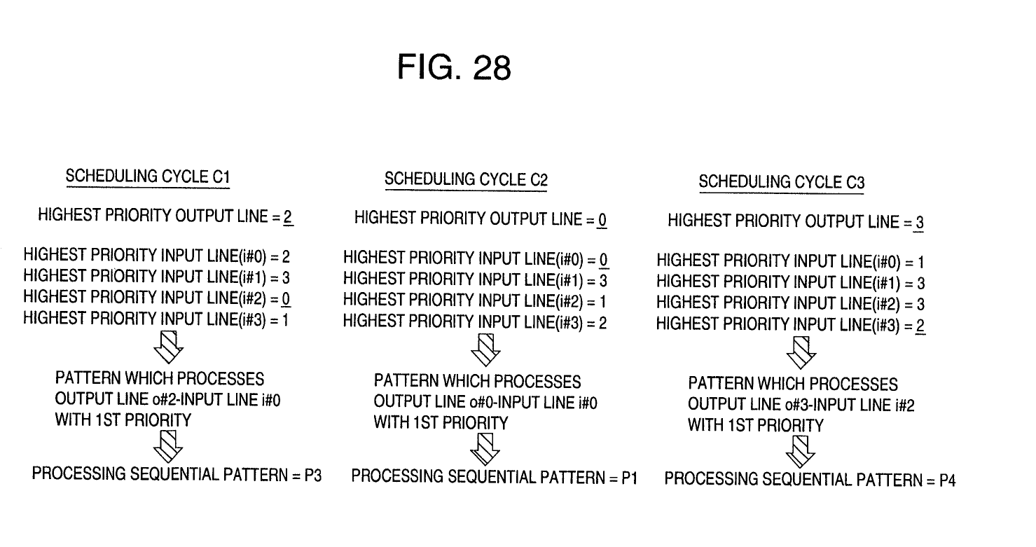

FIGS. 27 and 28 are diagrams for explaining this fourth embodiment of the scheduling method according to the present invention. FIGS. 27 and 28 show sequential patterns for a case where the correspondences of the input lines and the output lines are switched from those shown in FIGS. 4 and 5. In FIG. 27, numerals within the matrix indicate the input line numbers, and the uppermost row indicates the processing sequence of the output line o#0, and the lowermost row indicates the processing sequence of the output line o#3. In addition, the processing sequence of the scheduling process is selected by using the sequential pattern which processes the highest priority input line of the highest priority output line with the first priority. In the scheduling process, four output lines judge in parallel whether or not the scheduling target input line can be determined, successively for each of the first through Nth priorities.

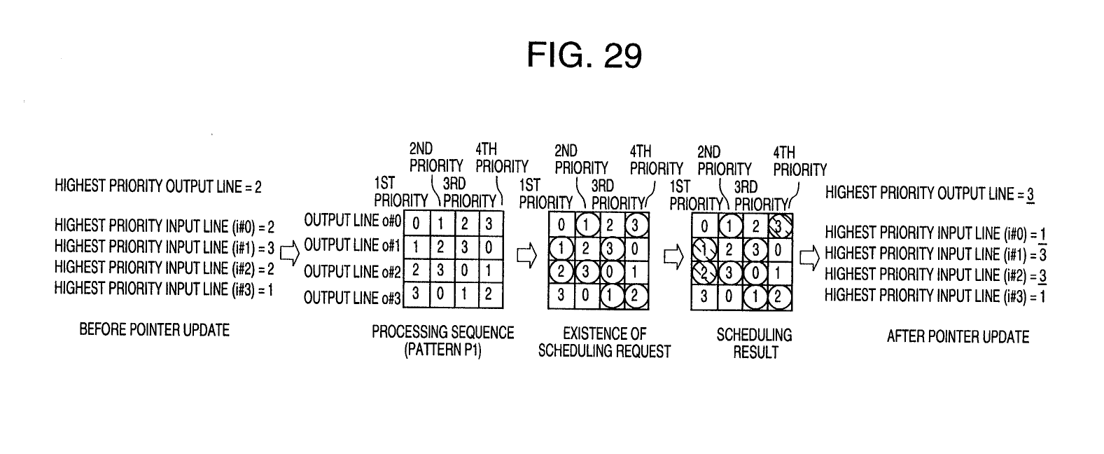

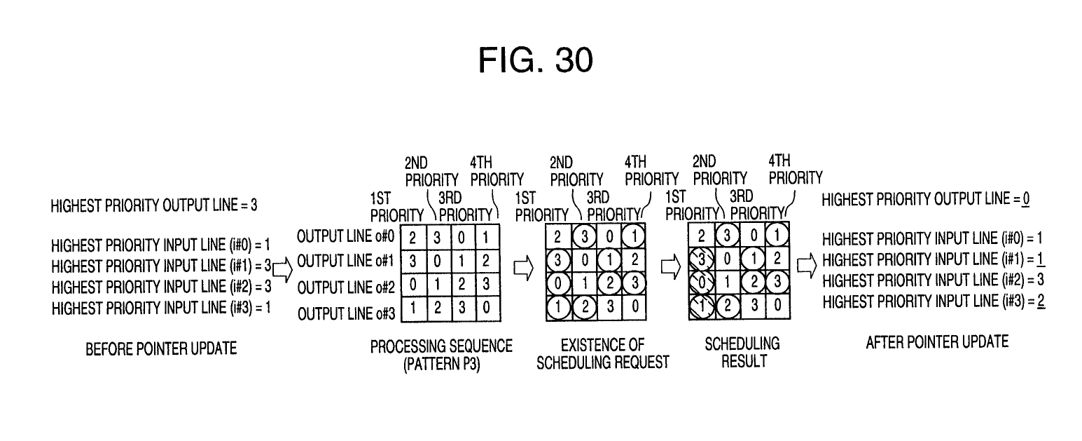

FIGS. 29 and 30 are diagrams for explaining a pointer initial value, a used processing pattern, an existence of scheduling request, a scheduling result, and a pointer value after pointer updating, for each scheduling cycle. In FIGS. 29 and 30, a circular mark indicates an input line which is requested. For example, it is indicated in FIG. 29 that a request for the input line i#1 from the output line o#1 and a request for the input line i#2 from the output line o#2 exist with the first priority, and that no request exists from the output lines o#0 and o#3. The number of scheduling requests is managed by incrementing the number upon reception of the request from the input buffer section and decrementing the number upon completion of the scheduling. In order to simplify the description, it is assumed for the sake of convenience that two or more requests exist in a line which is presently requested, and that the existence state of the request does not change before and after the scheduling.

In the scheduling sequence pattern of the scheduling cycle C#1 shown in FIG. 29, the output line o#2 is the highest priority output line and the input line i#2 is the highest priority input line of the output line o#2. Hence, a sequential pattern P#1 which processes the output line o#2 and the input line i#2 wit the first priority is used. The scheduling process judges whether or not the scheduling is possible, successively for the first through Nth priorities of the sequential pattern, by N parallel processes.

It is judged that the scheduling is possible if the processing output line is undetermined, the input line which is the scheduling target is undetermined, and the request information exists. On the other hand, it is judged that the scheduling is not possible if these conditions are not satisfied. When it is judged that the scheduling is possible, the scheduling result is held by putting the processing output line and the corresponding input line to the determined state. In the first priority process, for example, all of the output lines are undetermined, and all of the input lines are undetermined. Thus, since the output lines o#1 and o#2 in which the scheduling request exists both satisfy all of the conditions described above, it is judged that the scheduling of these output lines o#1 and o#2 is possible. In FIGS. 29 and 30, a state where the scheduling is determined is indicated by shading.

Next, in the second priority process, the output line o#0 waits for the request of the input line i#1, but because the input line i#1 is already determined by the output line o#1, the above described conditions are not satisfied and the input line i#1 cannot be determined. In addition, the output line o#2 waits for the request of the input line i#3, but the above described conditions are not satisfied since the output line o#2 is already determined. Therefore, no line can be determined by this second priority process. Similarly, in the third priority process, the above described conditions are not satisfied by any of the lines. In the fourth priority process, the input line i#3 of the output line o#0 satisfies the above described conditions, and the input line i#3 is determined.

As a result, the following results are obtained as the scheduling result of the scheduling cycle C#1. That is, the output line o#0 is connected to the input line i#3, the output line o#1 is connected to the input line i#1, the output line o#2 is connected to the input line i#2, and the output line o#3 is not connected. Hence, no read can be made from the output line o#3.

Next, the highest priority output line is updated by selecting the output line having the scheduling request with priority, based on the request information after completion of the scheduling. In this case, the search is started from {(present highest priority output line)+1} MOD N, and the output line having the first detected scheduling request is regarded as the next highest priority output line. In the scheduling cycle C#1 shown in FIG. 29, the present highest priority output line is the output line o#2. Hence, the search is started from the output line o#3 (o#(2+1)), and the output line o#3 having the first detected scheduling request is regarded as the next highest priority output line. Updated portions are underlined in FIG. 29 to clarify the existence of pointer updating.

In the updating process with respect to the highest priority input line of each output line, an unbiased scheduling is carried out with respect to a plurality of input lines of the output line. Accordingly, the highest priority input line is updated independently for each output line, based on the scheduling result of each output line and the existence of the scheduling request.

When the updating process is described with reference to FIG. 29, it may be seen that the input line i#3 is first determined because the output line o#0 does not have a request in the present highest priority input line i#2. A search is started from the input line i#0 which is obtained from {(determined input line number(#3))+1} MOD N (=0), and the input line i#1 having the first detected request is regarded as the next highest priority input line. The output line o#1 has a request in the input line i#3 which is the present highest priority input line, the output line o#3 has a request in the input line i#1 which is the present highest priority input line, and these present priority input lines are held because these lines cannot be determined. For this reason, the highest priority input lines of the output lines o#1 and o#3 are not updated. In addition, the output line o#2 has a request in the input line i#2 which is the present highest priority input line and this input line i#2 is determined. Thus, a search is started from {(determined input line(i#2)+1} MOD N, and the input line i#3 having the first detected request is regarded as the next highest priority input line.

In the scheduling cycle C#2 shown in FIG. 30, the scheduling is carried out by a similar procedure according to the pattern P#3 which processes the output line o#3 and the input line i#1 with the first priority, responsive to the result of updating the highest priority input and output lines during the scheduling cycle C#1. Furthermore, it is possible to carry out the QoS control and the selection of the priority line by means similar to those of the second and third embodiments described above.

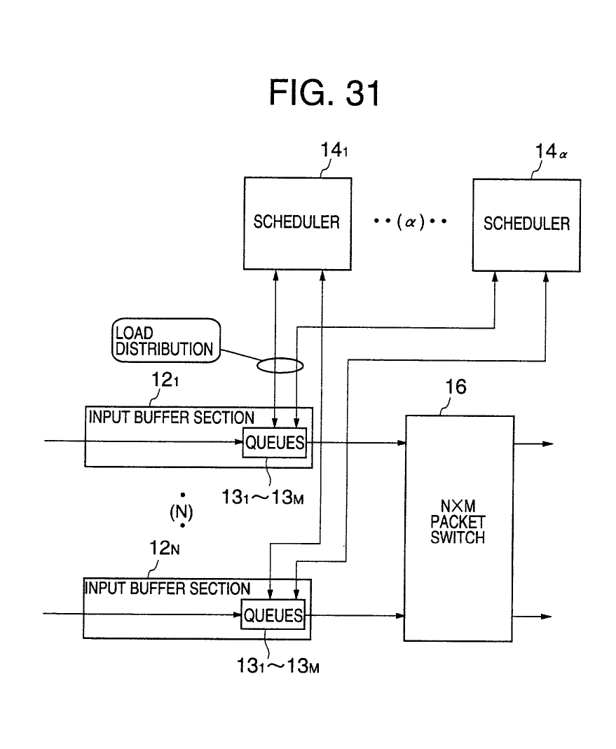

FIG. 31 is a system block diagram showing a second embodiment of the input buffer type switch used by a fifth embodiment of the scheduling method according to the present invention. In FIG. 31, those parts which are the same as those corresponding parts in FIG. 3 are designated by the same reference numerals, and a description thereof will be omitted.

In the case of a large scale switch shown in FIG. 31 such that the scheduling process of N lines does not end within the time of one packet, a total of a schedulers 14₁ through 14_{α} are provided, and the a schedulers 14₁ through 14_{α} carry out parallel processes according to the scheduling process of any of the first through fourth embodiments described above, so as to improve the throughput. The time of one packet (one packet time) refers to a time for which one packet is transmitted on a transmission channel, and one packet time is 205.76×10⁻⁹ when the transmission rate of the transmission channel is 24 Gbps and the packet length is 64 bytes.

The value of a is equal to the time required to carry out the scheduling process for N lines. In a case where the scheduling process for N lines takes four packet times, for example, four schedulers are provided. In addition, when a packet arrives at one of the input buffer sections 12₁ through 12_{N}, the scheduling request is notified to one of the four schedulers 14₁ through 14₄.

The four schedulers 14₁ through 14₄ carry out the scheduling independently of each other, and notify the scheduling results to the input buffer sections 12₁ through 12_{N}. In the input buffer sections 12₁ through 12_{N}, the first packet of the specified line is read without being aware of which one of the four schedulers 14₁ through 14₄ notified the scheduling result, and it is possible to transfer the packet without reversing the packet sequence.

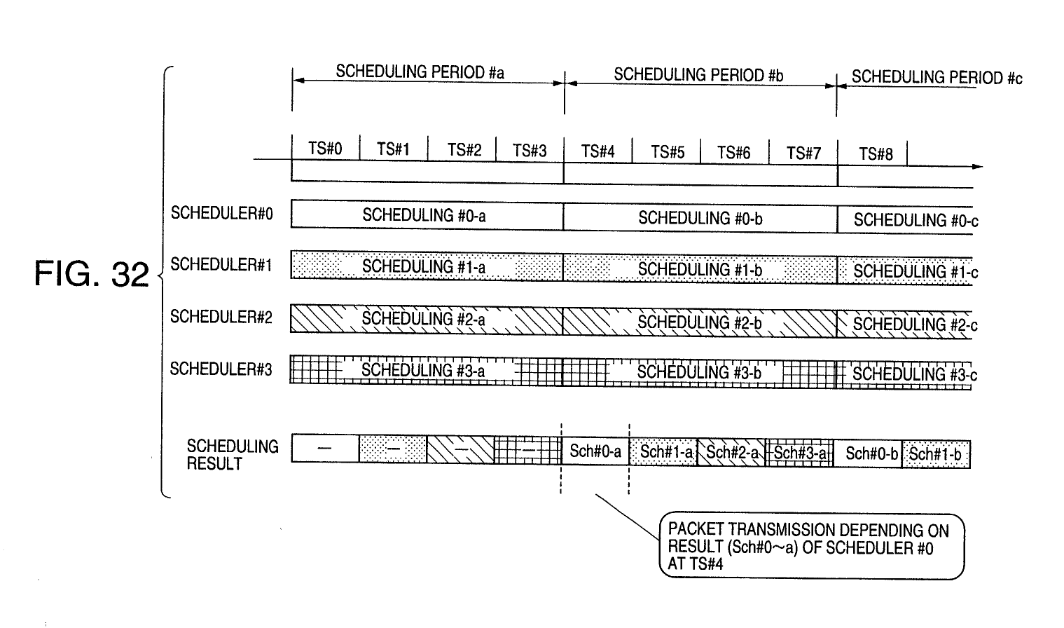

FIG. 32 is a diagram showing a relationship of processes of four schedulers 14₁ through 14₄ (#0 through #3) and packet transmissions. Each of the schedulers #0 through #3 carries out the scheduling in four unit times (=1 packet time) TS#0 through TS#3, and an arbitrary scheduler notifies the scheduling result to each of the input buffer sections 12₁ through 12_{N} for every unit time TS, so as to improve the throughput.

Accordingly, it is possible to realize a large-scale switch using general devices, without having to use ultra high-speed devices. In addition, according to the scheduling method of the present invention, the scheduling is carried out in parallel by a schedulers 14₁ through 14_{α}, thereby making it possible to carry out the scheduling in a relatively short time. In other words, the scheduling process of the large-scale switch can be realized by a small number of schedulers.

According to the present invention, it is possible to realize an unbiased scheduling by managing the output lines which are to be processed with the highest priority for each input line, for example, and processing all of the lines in parallel according to the highest priority output line of the highest priority input line. It is also possible to reduce the time required for the scheduling process. For this reason, it is possible to realize a scheduling with small delay and high throughput.

Moreover, by scheduling the line having a large load or a line having a packet with a high priority QoS, it is possible to obtain a satisfactory throughput under various traffic conditions, and to guarantee the QoS with respect to the priority class or group.

The steps S10 through S12, S50 through S52, S100 through S104, S110 through S114, S130 through S136, S140 through S144, S150 through S154, and S170 through S176 form a scheduling processing means. The steps S14 through S40, S54 through S92, S106 through S108, S116 through S120, S138, S146 through S148, S156 through S160, and S178 form a priority line updating means.

Further, the present invention is not limited to these embodiments, but various variations and modifications may be made without departing from the scope of the present invention.

What is claimed is:

1. A scheduling method comprising the steps of:
(a) processing scheduling processes of all input lines according to a processing sequence in which a highest priority output line of a highest priority input line is processed with a first priority, in an environment in which a plurality of processing sequences have different scheduling targets among a plurality of input lines; and
(b) updating the highest priority input line and the highest priority output line of each input line for every scheduling cycle.

2. The scheduling method as claimed in claim 1, wherein said step (b) selects with priority a line in which a packet exists, when updating the highest priority input line and the highest priority output line of each input line.

3. A scheduling apparatus comprising:
scheduling processing means for processing scheduling processes of all input lines according to a processing sequence in which a highest priority output line of a highest priority input line is processed with a first priority, in an environment in which a plurality of processing sequences have different scheduling targets among a plurality of input lines; and
priority line updating means for updating the highest priority input line and the highest priority output line of each input line for every scheduling cycle.

4. The scheduling apparatus as claimed in claim 3, wherein said priority line updating means selects with priority a line in which a packet exists, when updating the highest priority input line and the highest priority output line of each input line.

5. The scheduling apparatus as claimed in claim 4, wherein said priority line updating means does not update the highest priority output line of each input line when updating the highest priority output line if the highest priority output line cannot be scheduled.

6. The scheduling apparatus as claimed in claim 4, wherein said priority line updating means updates the highest priority output line of each input line by selecting a priority line within the output lines with priority over a non-priority line within the output lines.

7. The scheduling apparatus as claimed in claim 6, wherein said scheduling processing means independently manages the highest priority output line with respect to the priority line and the non-priority line.

8. The scheduling apparatus as claimed in claim 6, wherein said scheduling processing means collectively manages the highest priority output line with respect to the priority line and the non-priority line.

9. The scheduling apparatus as claimed in claim 6, wherein said scheduling processing means carries out a scheduling with respect to the non-priority line after carrying out a scheduling with respect to the priority line in a first half of a scheduling cycle.

10. The scheduling apparatus as claimed in claim 6, wherein said scheduling processing means carries out schedulings with respect to the priority line and the non-priority line in parallel, and selects a scheduling result of the priority line with priority when a contention is generated between the scheduling result of the priority line and a scheduling result of the non-priority line.

11. The scheduling apparatus as claimed in claim 4, wherein said priority line updating means selects and updates a high priority group within the output lines with priority over a low priority group within the output lines when updating the highest priority output line of each input line.

12. The scheduling apparatus as claimed in claim 11, wherein said scheduling processing means independently manages the highest priority output line with respect to the high priority group and the low priority group.

13. The scheduling apparatus as claimed in claim 11, wherein said scheduling processing means collectively manages the highest priority output line with respect to the high priority group and the low priority group.

14. A scheduling apparatus comprising:
scheduling processing means for processing scheduling processes of all output lines according to a processing sequence in which a highest priority input line of a highest priority output line is processed with a first priority, in an environment in which a plurality of processing sequences have different scheduling targets among a plurality of output lines; and
priority line updating means for updating the highest priority output line and the highest priority input line of each output line for every scheduling cycle.
